(19) United States
(12) Patent Application Publication
(10) Pub. No.: US 2012/0183768 A1
(43) Pub. Date: Jul. 19, 2012

(54) COATING FORMING COMPOSITION USED FOR FORMING TRANSPARENT CONDUCTIVE FILM

(75) Inventors: Yasuhiro Kondo, Chiba (JP); Keiichi Nakamoto, Chiba (JP); Setsuo Itami, Chiba (JP); Motoki Yanai, Chiba (JP)

(73) Assignee: JNC CORPORATION, TOKYO (JP)

(21) Appl. No.: 13/348,603

(22) Filed: Jan. 11, 2012

(30) Foreign Application Priority Data
Jan. 13, 2011 (JP) 2011-4519
Jun. 7, 2011 (JP) 2011-127165
Dec. 21, 2011 (JP) 2011-279719

(51) Int. Cl. H01B 1/22; B32B 15/098; B82Y 30/00

(52) U.S. Cl. 428/336; 252/512; 252/514; 977/762; 977/932

(57) ABSTRACT

A subject is to provide a material capable of obtaining a transparent conductive film having an excellent conductivity, optical transparency, environmental resistance, process resistance and close contact in a single application process, and to provide a transparent conductive film and a device element using the same. The means is to prepare a coating forming composition containing at least one kind of materials selected from the group of metal nanowires and metal nanotubes as a first component, polysaccharides and a derivative thereof as a second component, a thermosetting resin compound as a third component, and water as a fourth component to obtain a transparent conductive film by using the coating.

### CROSS-REFERENCE TO RELATED APPLICATION

This application claims the priority benefits of Japan patent application serial no. 2011-4519, filed on Jan. 13, 2011, the priority benefit of a Japan application serial no. 2011-127165, filed on Jun. 7, 2011 and the priority benefit of a Japan application serial no. 2011-279719, filed on Dec. 21, 2011. The entirety of each of the above-mentioned patent applications is hereby incorporated by reference herein and made a part of this specification.

### FIELD OF THE INVENTION

The present invention relates to a coating forming composition. More specifically, the invention relates to a substrate having a transparent conductive film, which has an excellent conductivity, optical transparency, environmental resistance and process resistance, obtained from the composition, and a device element using the substrate.

### BACKGROUND ART

A transparent conductive film is used in various fields such as a transparent electrode for a liquid crystal display (LCD), a plasma display panel (PDP), an organic electroluminescence element (OLED), a photovoltaic cell (PV) and a touch panel (TP), an anti-electrostatic discharge (ESD) film and an electromagnetic interference (EMI) film, and is required to have (1) a low surface resistance, (2) a high transmittance and (3) a high reliability.

Conventionally, indium tin oxide (ITO) has been applied to the transparent conductive film used for the transparent electrodes.

However, indium used for ITO has involved a problem of supply anxiety and price soaring. Moreover, a scale of manufacturing equipment becomes large, resulting in a long manufacturing time and a high cost because a sputtering method needing a high vacuum is used for forming an ITO film. Furthermore, the ITO film easily breaks by generating a crack due to a physical stress such as bending. A polymer of a flexible substrate is damaged because a high heat generates during the sputtering of the ITO film. Application of the sputtering method to a substrate provided with flexibility is difficult. Therefore, an ITO substitute material in which the problems are solved has been actively searched.

Consequently, as a material allowing application and film formation without needing sputtering among kinds of “ITO substitute material,” specific examples of materials have been reported, including (i) a polymer conductive material such as poly(3,4-ethylenedioxythiophene)-poly(4-styrenesulfonate) (PEDOT:PSS) (see Patent literature No. 1), (ii) a conductive material containing metal nanowires (see Patent literature No. 2 and Non-patent literature No. 1), (iii) a conductive material including a random network structure by fine silver particles (see Patent literature No. 3), (iv) a conductive material containing a conductive component having nanostructure, such as a conductive material containing carbon nanotubes (see Patent literature No. 4), and (v) a conductive material including a fine mesh using metal fine wiring (see Patent literature No. 5).

However, the material disclosed in (i) has a disadvantage of a low transmittance and a poor environmental resistance because the conductive material includes organic molecules, the material disclosed in (iii) has a disadvantage of a complex process because the transparent conductive film is prepared using self-organization, the material disclosed in (iv) has a disadvantage of a blackish color due to the carbon nanotubes and a reduced transmittance, and the material disclosed in (v) has a disadvantage of impossibility of conventional process utilization because a photographic technology is used.

Among the materials, the conductive material containing the metal nanowires disclosed in (ii) is optimum for “ITO substitute material” because the conductive material is reported to show a low surface resistance and a high transmittance (see Patent literature No. 2 and Non-patent literature No. 1, for example), and also has flexibility.

While the ITO substitute materials are being developed, reduction of an environmental load is also required. In recent years, suppression of organic solvent emission is promoted by a legal regulation and a voluntary approach by an enterprise. As one example of the approaches, a composition using water or a mixture of water and a water-soluble organic solvent as a solvent, the composition having a lower environmental load, as compared with the organic solvent, namely, an aqueous composition has been developed.

However, water is a peculiar liquid because water has characteristics not seen in the organic solvent, such as a large polarity, a hydrogen-bonding capability, having active hydrogen, and dissolving an ionic salt. Therefore, an organic compound that can be used in an aqueous solution is limited in view of stability in the aqueous solution, solubility to the aqueous solution, or the like. Thus, characteristics that can be easily achieved by using an organic solvent composition, such as dispersibility, process resistance and environmental resistance, can not be achieved in the aqueous composition.

Such poorness of process resistance of the aqueous composition becomes a problem in a conventional general manufacturing process.

For example, the transparent conductive film needs patterning according to an application. In general, a photolithographic method using a resist material is utilized for patterning. The photolithographic method includes processes of resist application, calcination, exposure, development, etching and peeling, and actually includes suitable substrate surface treatment, cleaning and drying processes before and after each process. In particular, the cleaning process is essential to an application to an electronic material or the like for preventing a particulate impurity, dirt and dust from depositing or entraining onto a substrate surface.

A coating formed using the aqueous composition is prepared using a compound easily dissolvable in water. Therefore, dissolution, peeling and so forth of the film occur particularly in a process using the aqueous solution, namely, the development, etching, peeling and cleaning processes. Furthermore, deterioration of characteristics of the coating occurs under a high temperature and a high humidity, and thus the coating has no sufficient environmental resistance.

The film forming composition as described in Patent literature No. 2 is considered to have a poor process resistance. Moreover, the transparent conductive films as described in Patent literatures No. 6 and No. 7 are prepared by forming a transparent conductive film using silver nanowires in a first layer, forming a film of an organic conductive material in a second layer, and further adding a crosslinkable compound to either one of the layers. According to the method, the environmental resistance is considered to be low because of the organic conductive material. Moreover, the number of processes increases because formation of two layers is essential.

Accordingly, an ITO substitute transparent conductive film that is excellent in (1) conductivity, (2) optical transparency, (3) environmental resistance and (4) process resistance, and for which the conventional general process can be used is required.

### CITATION LIST

### Patent Literature

Patent literature No. 1: JP 2004-59666 A.
Patent literature No. 2: JP 2009-505358 A.
Patent literature No. 3: JP 2008-78441 A.
Patent literature No. 4: JP 2007-112133 A.
Patent literature No. 5: JP 2007-270353 A.
Patent literature No. 6: JP 2010-244747 A.
Patent literature No. 7: JP 2010-205532 A.

### Non-Patent Literature

Non-patent literature No. 1: Shin-Hsiang Lai, Chun-Yao Ou, “SID 08 DIGEST,” 2008, pp. 1200-1202.

### SUMMARY OF INVENTION

### Technical Problem

An aim of the present invention is to provide a coating forming composition having an excellent dispersion and storage stability in an aqueous solution by using metal nanowires or metal nanotubes as a conductive component, and to provide a coating having an excellent conductivity, optical transparency, environmental resistance and process resistance in a single application process by using the composition.

### Solution to Problem

The inventors of the present invention have diligently continued to conduct research for achieving the aims, as a result, have found that a coating forming composition having an excellent dispersion and storage stability in an aqueous solution is obtained by adding a specific thermally crosslinkable resin or a compound having an alkoxysilyl group, or both of the specific crosslinkable resin and the compound to a composition in which metal nanowires or metal nanotubes are dispersed, and the composition forms a transparent conductive film having an excellent conductivity, optical transparency, environmental resistance and process resistance in a conventional general single application process, and thus have completed the present invention.

As for the specific thermally crosslinkable resin included in the present invention, thermally crosslinking a hydroxyl group of a water-soluble polymer compound with a thermosetting resin during calcination allows to improve environmental resistance and process resistance of a coating.

Moreover, the compound having the alkoxysilyl group included in the present invention forms a chemical bond with the hydroxyl group present on an applied substrate surface during calcination, and simultaneously has affinity with the water-soluble polymer compound. Alternatively, the compounds thermally crosslink with each other during calcination. The environmental resistance and the process resistance of the coating are improved by these functions.

The present invention concerns the following items 1 to 19, for example.

Item 1. A coating forming composition, containing at least one kind of materials selected from the group of metal nanowires and metal nanotubes as a first component, at least one kind of materials selected from the group of polysaccharides and a derivative thereof as a second component, a compound having at least one group selected from the group of a (block) isocyanate group, an amineimide group, an epoxy group, an oxetanyl group, an N-methylol group, an N-methylol ether group and an alkoxysilyl group as a third component, and water as a fourth component.
Item 2. The coating forming composition according to item 1, wherein the third component is a compound having the N-methylol group or the N-methylol ether group.
Item 3. The coating forming composition according to item 2, wherein the third component is a condensation product of at least one kind of compounds shown in the following group (A) and at least one kind of compounds shown in the following group (B):
(A) formaldehyde, paraformaldehyde and trioxane; and
(B) urea, melamine and benzoguanamine.
Item 4. The coating forming composition according to item 3, wherein the third component is a condensation product of formaldehyde and melamine.
Item 5. The coating forming composition according to item 4, wherein the third component is a compound having the N-methylol ether group.
Item 6. The coating forming composition according to item 1, wherein the third component is a compound having the alkoxysilyl group.
Item 7. The coating forming composition according to item 6, wherein the compound having the alkoxysilyl group has an amino group or an epoxy group.
Item 8. The coating forming composition according to item 7, wherein the third component is a compound represented by the following general formula (I) or (II):

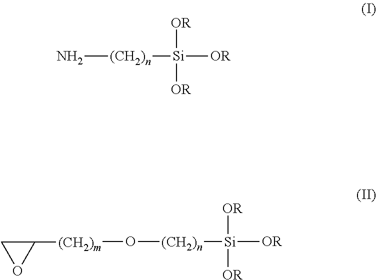

wherein R independently represents an alkyl group having 1 to 3 carbons, and n and m are independently an integer of 2 to 5.
Item 9. The coating forming composition according to item 6, wherein the third component is a compound represented by the following general formula (III):

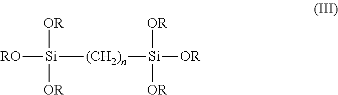

wherein R independently represents an alkyl group having 1 to 3 carbons, and n is an integer of 2 to 5.
Item 10. The coating forming composition according to any one of items 1 to 9, wherein the first component is silver nanowires.
Item 11. The coating forming composition according to item 10, wherein the first component is silver nanowires having a mean of length of a minor axis in the range of 5 nanometers or more to 100 nanometers or less, and a mean of length of a major axis in the range of 2 micrometers or more to 50 micrometers or less.
Item 12. The coating forming composition according to any one of items 1 to 11, wherein the second component is a cellulose ether derivative.
Item 13. The coating forming composition according to item 12, wherein the second component is hydroxypropyl methyl cellulose.
Item 14. The coating forming composition according to any one of items 1 to 13, containing at least one kind of compounds selected from an amine compound, salts and metal salts of the amine compound.
Item 15. The coating forming composition according to any one of items 1 to 14, wherein the first component is in the range of 0.01% by weight or more to 1.0% by weight or less based on the total weight of the coating forming composition, the second component is in the range of 50 parts by weight or more to 300 parts by weight or less based on 100 parts by weight of the first component, and the third component is in the range of 1.0 part by weight or more to 50 parts by weight or less based on 100 parts by weight of the second component.
Item 16. The coating forming composition according to any one of items 1 to 15, wherein viscosity at 25° C. is in the range of 10 mPa·s or more to 70 mPa·s or less.
Item 17. The coating forming composition according to any one of items 1 to 16, used for forming a coating having conductivity.
Item 18. A substrate having a transparent conductive film obtained using the coating forming composition according to item 17, wherein a film thickness of the transparent conductive film is in the range of 20 nanometers or more to 80 nanometers or less, a surface resistance of the transparent conductive film is in the range of 10 Ω/□ or more to 5,000 Ω/□ or less, and a total transmittance of the transparent conductive film is in the range of 85% or more.
Item 19. A device element, using the substrate according to item 18.

### Advantageous Effects of Invention

According to the present invention, a composition in which metal nanowires or metal nanotubes are favorably dispersed is obtained. Moreover, a coating having an excellent conductivity, optical transparency, environmental resistance, process resistance and close contact can be formed by applying the composition to a substrate in manufacturing a transparent conductive film. Moreover, the transparent conductive film obtained can have both a low surface resistance value and favorable optical properties such as a favorable transmittance.

### DESCRIPTION OF EMBODIMENTS

Hereinafter, the present invention will be specifically explained.

In the specification, “transparent conductive film” means a film having a surface resistance of approximately 10⁴ Ω/□ or less, and a total transmittance of approximately 80% or more. “Aqueous composition” means a composition in which a solvent in a composition is water or a mixture of water and a water-soluble organic solvent. “Binder” is a resin used for allowing a conductive material of metal nanowires or metal nanotubes to disperse in a conductive film and to support the conductive material thereon.

### 1. Coating Forming Composition

A coating forming composition of the present invention contains at least one kind of materials selected from the group of metal nanowires and metal nanotubes as a first component (hereinafter, referred to as the metal nanowires and the nanotubes sometimes), at least one kind of materials selected from the group of polysaccharides and a derivative thereof as a second component (hereinafter, referred to as the polysaccharides and the derivative thereof sometimes), a compound thermally crosslinking with a hydroxyl group of the second component or a compound having an alkoxysilyl group, or both of the compounds as a third component, and water as a fourth component.

### 1-1. First Component: Metal Nanowires and Metal Nanotubes

The coating forming composition of the present invention contains at least one kind of materials selected from the group of metal nanowires and metal nanotubes as the first component. The first component forms a network in a coating obtained from the composition of the present invention and gives conductivity to the coating.

In the specification, “metal nanowires” means a conductive material having a wire shape, and the metal nanowires may be linear or gently or steeply bent. Properties may be flexible or rigid.

In the specification, “metal nanotubes” means a conductive material having a porous or nonporous tubular shape, and the metal nanotubes may be linear or gently or steeply bent. Properties may be flexible or rigid.

Either the metal nanowires or the metal nanotubes may be used, or both may be mixed and used.

Specific examples of kinds of metals include at least one kind of materials selected from the group of gold, silver, platinum, copper, nickel, iron, cobalt, zinc, ruthenium, rhodium, palladium, cadmium, osmium and iridium, or an alloy obtained by combining the metals. From a viewpoint of obtaining a coating having a low surface resistance and a high total transmittance, at least one kind of any of gold, silver and copper is preferably contained. The metals have a high conductivity, and therefore density of the metal on a surface can be reduced upon obtaining a desired surface resistance, and thus a high transmittance can be realized. Above all, at least one kind of gold or silver is preferably contained. As an optimum embodiment, silver is preferred.

Length of a minor axis, length of a major axis and an aspect ratio of the first component in the coating forming composition have a fixed distribution. The distribution is selected from a viewpoint where the coating obtained from the composition of the present invention becomes high in the total transmittance and low in the surface resistance. Specifically, a mean of the length of the minor axis of the first component is preferably in the range of approximately 1 nanometer or more to approximately 500 nanometers or less, further preferably, approximately 5 nanometers or more to approximately 200 nanometers or less, still further preferably, in the range of approximately 5 nanometers or more to approximately 100 nanometers or less, particularly preferably, in the range of approximately 10 nanometers or more to approximately 100 nanometers or less. Moreover, a mean of the length of the major axis of the first component is preferably in the range of approximately 1 micrometer or more to approximately 100 micrometers or less, further preferably, in the range of approximately 1 micrometer or more to approximately 50 micrometers or less, still further preferably, approximately 2 micrometers or more to approximately 50 micrometers or less, particularly preferably, in the range of approximately 5 micrometers or more to approximately 30 micrometers or less. As for the first component, the mean of the length of the minor axis and the mean of the length of the major axis meet the ranges as described above, and a mean of the aspect ratio is preferably approximately 1 or more, further preferably, approximately 10 or more, still further preferably, approximately 100 or more, particularly preferably, approximately 200 or more. Herein, the aspect ratio is a value determined by a/b when a mean length of the minor axis and a mean length of the major axis of the first component are approximated as b and a, respectively. Then, a and b can be measured using a scanning electron microscope. In the present invention, scanning electron microscope SU-70 (made by Hitachi High-Technologies Corporation) is used.

As a method for manufacturing the first component, a known manufacturing method can be used. For example, the silver nanowires can be synthesized by reducing silver nitrate in the presence of polyvinylpyrrolidone by using a polyol process (Chem. Mater., 2002, 14, 4736). Moreover, the silver nanowires can also be synthesized by reducing silver nitrate through nucleus formation and a double jet method without using polyvinyl pyrrolidone, as described in Patent literature No. 5.

A diameter and length of nanowires can be controlled by changing reaction conditions or reducing agents, or adding a salt. The diameter and the length of nanowires are controlled by changing reaction temperatures and reducing agents in WO 2008/073143 A. The diameter can also be controlled by addition of potassium bromide (ACS NANO, 2010, 4, 5, 2955).

Gold nanowires can also be synthesized by reducing chloroaurate hydrate in the presence of polyvinylpyrrolidone in a similar manner (J. Am. Chem. Soc., 2007, 129, 1733). A technology for synthesizing and purifying the silver nanowires and the gold nanowires in a large scale is described in detail in WO 2008/073143 A and WO 2008/046058 A.

Gold nanotubes having a porous structure can be synthesized by using the silver nanowires as a mold and according to an oxidation-reduction reaction with the silver nanowires per se by using a chlorauric acid solution. A surface of the silver nanowires is covered with gold according to the oxidation-reduction reaction of silver with chloroauric acid, on the other hand, the silver nanowires used as the mold are dissolved out into the solution, and as a result, the gold nanotubes having the porous structure can be prepared (J. Am. Chem. Soc., 2004, 126, 3892-3901). Moreover, the silver nanowires as the mold can also be removed by using an aqueous ammonia solution (ACS NANO, 2009, 3 and 6, 1365-1372).

From a viewpoint of a high conductivity and transparency, content of the first component is preferably in the range of approximately 0.01% by weight or more to approximately 1.0% by weight or less, further preferably, in the range of approximately 0.05% by weight or more to approximately 0.75% by weight or less, still further preferably, in the range of approximately 0.1% by weight or more to approximately 0.5% by weight or less based on the total amount of the first component to the fourth component.

### 1-2. Second Component: Polysaccharides and a Derivative Thereof

The coating forming composition of the present invention contains at least one kind of materials selected from the group of polysaccharides and a derivative thereof as the second component. The second component provides dispersibility in a water solvent for the first component by increasing a viscosity of the composition. The second component forms a film and simultaneously connects the film formed with the substrate during film formation. Moreover, the second component plays a role of a binder. The second component is considered to exhibit functions such as a favorable dispersibility, a high conductivity and a high optical transparency without adversely affecting dispersibility of the first component in the composition, and without destroying a conductive network that the first component of the composition of the present invention forms in the coating obtained from the composition. Furthermore, the hydroxyl group present in molecules of the second component crosslinks with the third component.

Specific examples of the polysaccharides and the derivative thereof to be used for the composition of the present invention include polysaccharides such as starch, gum arabic, hydroxypropyl methyl cellulose, carboxymethyl cellulose, hydroxyethyl cellulose, methyl hydroxyethyl cellulose, chitosan, dextran, guar gum and glucomannan, and a derivative thereof. The polysaccharides and the derivative thereof are preferably polysaccharides such as xanthan gum, hydroxypropyl methyl cellulose, carboxymethyl cellulose, hydroxyethyl cellulose, methyl hydroxyethyl cellulose, dextran, guar gum and glucomannan, and a derivative thereof, further preferably, a cellulose ether derivative such as hydroxypropyl methyl cellulose, methyl hydroxyethyl cellulose, carboxymethyl cellulose, methylcellulose, and ethylcellulose, particularly preferably, hydroxypropyl methyl cellulose. In the second component, polysaccharides having a carboxylate, sulfonate and phosphate and a derivative thereof may be a salt of sodium, potassium, calcium, ammonium or the like, and polysaccharides having a nitrogen atom and a derivative thereof may have a structure of hydrochloride, citrate or the like. The second component can be used in one kind or in a plurality of kinds. When using a plurality of kinds, the polysaccharides only or the derivative thereof only, or a mixture of the polysaccharides and the derivative thereof may be used.

As a viscosity of the polysaccharides and the derivative thereof concerning the present invention is higher, a more uniform dispersibility is obtained for a long period of time because precipitation of metal nanowires and metal nanotubes is suppressed. Furthermore, a higher conductivity is obtained because a higher silver nanowires density with a thicker film is obtained. On the other hand, as the viscosity is lower, smoothness and uniformity of the coating are more satisfactory. As described above, as the viscosity of the polysaccharides and the derivative thereof concerning the present invention, a viscosity at 20° C. of a 2.0 wt. % aqueous solution is preferably in the range of approximately 4,000 mPa·s or more to approximately 1,000,000 mPa·s or less, further preferably, in the range of approximately 10,000 mPa·s or more to approximately 200,000 mPa·s or less.

For example, with regard to hydroxypropyl methyl cellulose, weight average molecular weight is preferably in the range of approximately 300,000 or more to approximately 3,000,000 or less, further preferably, in the range of approximately 400,000 or more to approximately 900,000 or less. Viscosity is proportional to molecular weight, and when a solution of an identical concentration is measured under identical conditions, a material having a higher viscosity has a higher molecular weight, and a material having a lower viscosity has a lower molecular weight.

From a viewpoint of a favorable dispersibility, a high transmittance, film forming properties and close contact relative to the first component in the composition, content of the second component is preferably in the range of approximately 50 parts by weight or more to approximately 300 parts by weight or less, further preferably, in the range of approximately 75 parts by weight or more to approximately 250 parts by weight or less, still further preferably, in the range of approximately 100 parts by weight or more to approximately 200 parts by weight or less based on 100 parts by weight of the first component.

As a commercial product, Metolose 90SH-100000, Metolose 90SH-30000, Metolose 90SH-15000, Metolose 90SH-4000, Metolose 65SH-15000, Metolose 65SH-4000, Metolose 60SH-10000, Metolose 60SH-4000, Metolose SM-8000, Metolose SM-4000 and Metolose SHV-PF (trade name) (made by Shin-Etsu Chemical Co., Ltd.), Methocel K100M, Methocel K15M, Methocel K4M, Methocel F4M, Methocel E10M and Methocel E4M (trade name) (made by the Dow Chemical Company) can be used, for example.

### 1-3. Third Component

The coating forming composition of the present invention contains the compound thermally crosslinking with the hydroxyl group of the second component, the compound having the alkoxysilyl group, or both of the compounds as the third component.

The third component increases physical strength of the film, decreases water solubility and improves environmental resistance, process resistance and close contact accompanied therewith out adversely affecting dispersibility of the first component in the composition and without destroying a network formed by the first component of the composition of the present invention in the coating obtained from the composition, and without worsening conductivity and optical properties.

A. Compound Thermally Crosslinking with the Hydroxyl Group of the Second Component

The compound thermally crosslinking with the hydroxyl group of the second component reduces water solubility of the second component and simultaneously increases physical strength of a film by crosslinking between the second component and the third component of the present invention during calcination. Crosslinking uniformly exists wholly in the film, and contributes to increasing strength. A transparent conductive film of the present invention has one layer, and therefore peeling on a film interface does not occur because crosslinking is more uniform, as compared with a multilayer transparent conductive film. A decrease in water solubility of the film by crosslinking prevents a water-soluble solvent from penetration into the film. Thus, an etching phenomenon of parts covered with a photoresist (referred to as under etching) is prevented upon etching, and an applicable range (margin) of a concentration, temperature or dipping time of an etching solution is extended.

In addition, the compound may react with a part of hydroxy groups without needing to react with all hydroxyl groups in the second component.

The compound contains a thermally reactive group thermally crosslinking with the hydroxyl group of the second component. The compound may have one kind or a plurality of kinds of the thermally reactive groups, furthermore, two or a plurality of the thermally reactive groups in one molecule. Specific examples of the thermally reactive groups include an isocyanate group, an epoxy group, an oxetanyl group and an N-methylol group. Herein, the N-methylol group is a functional group formed through a reaction of a compound having at least one kind of materials selected from the group of formaldehyde, paraformaldehyde, trioxane and hexamethylentetramine with an amino group or an amide group, and may be etherified by any alcohol. Moreover, the isocyanate group may be a (block) isocyanate group prepared by protecting the isocyanate group with any alcohol or an amineimide group as a precursor of the isocyanate group. The compound thermally crosslinking with the hydroxyl group of the second component is preferably a compound having a (block) isocyanate group, an amineimide group, an epoxy group, an oxetanyl group, an N-methylol group or an N-methylol ether group, further preferably, a compound having a (block) isocyanate group, an epoxy group, an N-methylol group or an N-methylol ether group, still further preferably, a compound having an N-methylol group or an N-methylol ether group.

As the compound having the thermally reactive group, (meth)acrylate, (meth)acrylamide, phenolic resin, amino resin, epoxy resin, and a precursor thereof can be used, for example. Moreover, the compound can also be used in one kind or in a plurality of kinds. When using the phenolic resin, amino resin, epoxy resin or the precursor thereof, a catalyst or the like is preferably used. The catalyst or the like as described later may be used in one kind or a plurality of kinds. The compound thermally crosslinking with the hydroxyl group of the second component is preferably (meth)acrylate, (meth)acrylamide, amino resin and epoxy resin, further preferably, amino resin, still further preferably, a compound having N-methylol melamine or etherified N-methylol melamine.

### A-1. Phenolic Resin

As a phenolic resin that can be used as the compound thermally crosslinking with the hydroxyl group of the second component of the present invention, novolak resin obtained by a condensation reaction of an aromatic compound having a phenolic hydroxyl group with aldehydes, a homopolymer of vinylphenol (including a hydrogenated product thereof), a vinylphenolic copolymer of vinylphenol with a compound copolymerizable therewith (including a hydrogenated product thereof) or the like is preferably used.

Specific examples of the aromatic compounds having the phenolic hydroxyl group include phenol, o-cresol, m-cresol, p-cresol, o-ethylphenol, m-ethylphenol, p-ethylphenol, o-butylphenol, m-butylphenol, p-butylphenol, o-xylenol, 2,3-xylenol, 2,4-xylenol, 2,5-xylenol, 3,4-xylenol, 3,5-xylenol, 2,3,5-trimethylphenol, 3,4,5-trimethylphenol, p-phenylphenol, resorcinol, hydroquinone, hydroquinone monomethyl ether, a pyrogallol, bisphenol A, bisphenol F, terpene skeleton-containing diphenol, gallic acid, gallate, a-naphthol and β-naphthol.

Specific examples of the aldehydes include formaldehyde, paraformaldehyde, trioxane and hexamethylentetramine.

Specific examples of the compounds copolymerizable with vinylphenol include (meth) acrylic acid or a derivative thereof, styrene or a derivative thereof, maleic anhydride, vinyl acetate and acrylonitrile.

As the phenolic resin, various kinds of commercial products can be used. Specific examples include TD-4304, PE-201L and PE-602L (trade name) (DIC, Inc.), and Shonol BRL-103, BRL-113, BRP-408A, BRP-520, BRL-1583 and BRE-174 (trade name) (Showa Denko K.K.).

The phenolic resin may be used in one kind or in combination of two or more kinds.

### A-2. Amino Resin

An amino resin that can be used as the compound thermally crosslinking with the hydroxyl group of the second component of the present invention is not particularly limited, if the amino resin is a condensation product of a compound having an aldehyde group and a compound having an amino group or an amide group. Herein, the compound having the aldehyde group is a compound having at least one kind of materials selected from the group of formaldehyde, paraformaldehyde, trioxane and hexamethylentetramine. Specific example of the amino resins include methylol urea resin, methylol melamine resin, etherified methylol melamine resin, benzoguanamine resin, methylol benzoguanamine resin, etherified methylol benzoguanamine resin and a condensation product thereof. Among the amino resins, methylol melamine resin and etherified methylol melamine resin are preferred in view of a favorable water solubility at a time point before crosslinking, a favorable process resistance and environmental resistance after film formation.

When the etherified methylol melamine resin is used as the amino resin, a high storage stability can also be provided for the composition. The etherified methylol melamine resin has an excellent storage stability because of having an N-methylol ether group that has a lower reactivity, as compared with the methylol group. For the purpose of controlling a thermal crosslinking reaction with the hydroxyl group of the second component, or the like, an amino resin catalyst and a reaction initiator may be appropriately used.

As the compound having the aldehyde group, formaldehyde, paraformaldehyde, trioxane and hexamethylentetramine are preferred in view of a favorable water solubility at a time point before crosslinking, a favorable process resistance and environmental resistance after film formation.

Specific examples of the compounds having the amino group or the amide group include urea, melamine and benzoguanamine.

Furthermore, a combination of formaldehyde and melamine is particularly preferred because the compound per se can work as a corrosion inhibitor and further improve environmental resistance of the coating.

As the amino resin, various kinds of commercial products can be used. Specific examples include Riken Resin RG-80, Riken Resin RG-10, Riken Resin RG-1, Riken Resin RG-1H, Riken Resin RG-85, Riken Resin RG-83, Riken Resin RG-17, Riken Resin RG-115E, Riken Resin RG-260, Riken Resin RG-20E, Riken Resin RS-5S, Riken Resin RS-30, Riken Resin RS-150, Riken Resin RS-22, Riken Resin RS-250, Riken Resin RS-296, Riken Resin HM-272, Riken Resin HM-325, Riken Resin HM-25, Riken Resin MA-156, Riken Resin MA-100, Riken Resin MA-31, Riken Resin MM-3C, Riken Resin MM-3, Riken Resin MM-52, Riken Resin MM-35, Riken Resin MM-601, Riken Resin MM-630, Riken Resin MS and Riken Resin MM-65S (trade name) (Miki Riken Industrial Co., Ltd.), Bechamine NS-11, Bechamine LF-K, Bechamine LF-R, Bechamine LF-55P concentrated, Bechamine NS-19, Bechamine FM-28, Bechamine FM-7, Bechamine NS-200, Bechamine NS-210L, Bechamine FM-180, Bechamine NF-3, Bechamine NF-12, Bechamine NF-500K, Bechamine E, Bechamine N-13, Bechamine N-80, Bechamine J-300S, Bechamine N, Bechamine APM, Bechamine MA-K, Bechamine MA-S, Bechamine J-101, Bechamine J-101LF, Bechamine M-3, Bechamine M-3(60), Bechamine A-1, Bechamine R-25H, Bechamine V-60 and Bechamine 160 (trade name) (DIC, Inc.), Nica Resin S-176 and Nica Resin 260 (trade name) (Nippon Carbide Industries Co., Inc.), and Nikalac MW-30M, Nikalac MW-30, Nikalac MW-22, Nikalac MX-730, Nikalac MX-706, Nikalac MX-035, Nikalac MX-45 and Nikalac BX-4000 (trade name) (Sanwa Chemical Co., Ltd.).

The amino resin may be used in one kind and in combination of two or more kinds.

### A-2-1. Amino Resin Catalyst and Reaction Initiator

When the coating forming composition of the present invention contains the amino resin or the precursor, the coating forming composition preferably contains a catalyst or a reaction initiator in order to further improve self-hardening properties. Specific examples of such catalysts include organic acids such as an aromatic sulfonic acid compound and a phosphoric acid compound and a salt thereof, an amine compound, salts of the amine compound, an imine compound, an amidine compound, a guanidine compound, a heterocyclic compound containing a N atom, an organometallic compound, and metal salts such as zinc stearate, zinc myristate, aluminum stearate and calcium stearate. Specific examples of the reaction initiators include a photoacid generator and a photobase generator.

The amino resin catalyst and the reaction initiator may be used in one kind or in combination of two or more kinds. Moreover, an amino resin catalyst and a reaction initiator based on a different mechanism may be used.

From a viewpoint of reactivity, a favorable dispersibility of each component in the composition, and a high conductivity, a favorable optical transparency, a favorable environmental resistance, a favorable process resistance and a favorable close contact of the coating obtained from the composition of the present invention, content of the amino resin catalyst and the reaction initiator in the coating forming composition of the present invention is preferably in the range of approximately 0.1 part by weight or more to approximately 100 parts by weight or less, further preferably, in the range of approximately 1 part by weight or more to approximately 50 parts by weight or less, still further preferably, in the range of approximately 5 parts by weight or more to approximately 25 parts by weight or less based on 100 parts by weight of the amino resin or the precursor.

As the amino resin catalyst, various kinds of commercial products can be used. Specific examples include Riken Fixer RC, Riken Fixer RC-3, Riken Fixer RC-12, Riken Fixer RCS, Riken Fixer RC-W, Riken Fixer MX, Riken Fixer MX-2, Riken Fixer MX-18, Riken Fixer MX-18N, Riken Fixer MX-36, Riken Fixer MX-15, Riken Fixer MX-25, Riken Fixer MX-27N, Riken Fixer MX-051, Riken Fixer MX-7, Riken Fixer DMX-5, Riken Fixer LTC-66, Riken Fixer RZ-5, Riken Fixer XT-329, Riken Fixer XT-318, Riken Fixer XT-53, Riken Fixer XT-58 and Riken Fixer XT-45 (trade name) (Miki Riken Industrial Co., Ltd.), Catalyst 376, Catalyst ACX, Catalyst O, Catalyst M, Catalyst X-80, Catalyst G, Catalyst X-60, Catalyst GT, Catalyst X-110, Catalyst GT-3, Catalyst NFC-1 and Catalyst ML (trade name) (DIC, Inc.), Nacure 155, Nacure 1051, Nacure 5076, Nacure 4054J, Nacure 2500, Nacure 5225, Nacure X49-110 and Nacure 4167 (trade name) (U.S. King Industries, Inc.).

### A-2-2. Amino Resin Additive

For the purpose of improving storage stability of the amino resin, an alcohol may be added in the range where characteristics of the present invention are not adversely affected. Specific examples of the alcohols that can be used for the present invention include methanol, ethanol, isopropyl alcohol and butanol. Content of the alcohol is preferably in the range of approximately 0.1 part by weight or more to approximately 20 parts by weight or less, further preferably, in the range of approximately 0.5 part by weight or more to approximately 10 parts by weight or less, still further preferably, in the range of approximately 1 part by weight or more to approximately 5 parts by weight or less. The amino resin additive may be used in one kind or in a plurality of kinds.

### A-3. Epoxy Resin

In the composition of the present invention, the epoxy resin having the epoxy group or the oxetanyl group in a molecule can be used as the composition thermally crosslinking with the hydroxyl group of the second component. Specific examples of the epoxy resins include a phenol-novolak, cresol-novolak, bisphenol A, bisphenol F, hydrogenated bisphenol A, hydrogenated bisphenol F, bisphenol S, trisphenol methane, tetraphenol ethane, bixylenol or biphenol epoxy compound; an alicyclic or heterocyclic epoxy compound; an epoxy compound having dicyclopentadiene or naphthalene structure; and an epoxy compound having ethylene oxide structure.

Moreover, specific examples of the epoxy resins include N,N,N′,N′-tetraglycidyl-m-xylenediamine, 1,3-bis(N,N-diglycidylaminomethyl)cyclohexane and N,N,N′,N′-tetraglycidyl-4,4′-diaminodiphenylmethane.

As the epoxy resin, various kinds of commercial products can be used for the reason of a favorable water solubility at a time point before crosslinking and a favorable process resistance and environmental resistance after film formation. Specific examples include Denacol EX-614B, Denacol EX-512, Denacol EX-521, Denacol EX-421, Denacol EX-313, Denacol EX-314, Denacol EX-810, Denacol EX-811, Denacol EX-851, Denacol EX-821, Denacol EX-830, Denacol EX-841, Denacol EX-832 and Denacol EX-861 (trade name) (Nagase ChemteX Corporation).

The epoxy resin used for the composition of the present invention may include one kind or a mixture of two or more kinds.

### A-3-1. Epoxy Curing Agent

When the coating forming composition of the present invention contains the epoxy resin, the composition preferably further contains an epoxy curing agent in view of further improving a chemical resistance thereof. As the epoxy curing agent, an acid anhydride curing agent, a polyamine curing agent, a catalyst curing agent or the like is preferred. Moreover, an acid generator, a base generator or the like can be used as the epoxy curing agent.

Specific examples of the acid anhydride curing agents include maleic anhydride, tetrahydrophthalic anhydride, hexahydrophthalic anhydride, methylhexahydrophthalic anhydride, hexahydrotrimellitic anhydride, phthalic anhydride, trimellitic anhydride and a styrene-maleic anhydride copolymer. Content of the acid anhydride curing agent is preferably in the range of approximately 1 part by weight or more to approximately 200 parts by weight or less, further preferably, in the range of approximately 50 parts by weight or more to approximately 150 parts by weight or less, still further preferably, in the range of approximately 80 parts by weight or more to approximately 120 parts by weight or less based on 100 parts by weight of the epoxy resin.

Specific examples of the polyamine curing agents include diethylenetriamine, triethylenetetramine, tetraethylenepentamine, dicyandiamide, polyamideamine (polyamide resin), a ketimine compound, isophorone diamine, m-xylenediamine, m-phenylenediamine, 1,3-bis(aminomethyl)cyclohexane, N-aminoethylpiperazine, 4,4′-diaminodiphenylmethane, 4,4′-diamino-3,3′-diethyldiphenylmethane and diaminodiphenylsulfone. Content of the polyamine curing agent is preferably in the range of approximately 1 part by weight or more to approximately 100 parts by weight or less, further preferably, in the range of approximately 5 parts by weight or more to approximately 80 parts by weight or less, still further preferably, in the range of approximately 10 parts by weight or more to approximately 50 parts by weight or less based on 100 parts by weight of the epoxy resin.

Specific examples of the catalyst curing agents include a tertiary amine compound and an imidazole compound. Content of the acid catalyst curing agent is preferably in the range of approximately 1 part by weight or more to approximately 100 parts by weight or less, further preferably, in the range of approximately 5 parts by weight or more to approximately 80 parts by weight or less, still further preferably, in the range of approximately 10 parts by weight or more to approximately 50 parts by weight or less based on 100 parts by weight of the epoxy resin.

The epoxy curing agent may be used in one kind or in combination of two or more kinds.

A-4. Examples of Thermal Crosslinking with Polysaccharides and a Derivative Thereof

An aspect of thermal crosslinking when using hydroxypropyl methyl cellulose as the second component, and trimethylolmelamine as the third component is schematically shown in the following scheme (1). In addition, structure of hydroxypropyl methyl cellulose is expressed by replacing any hydroxyl group by a methyl ether group and a hydroxypropyl ether group in a repeating unit of p-cellulose. The present invention is not limited to the following scheme (1).

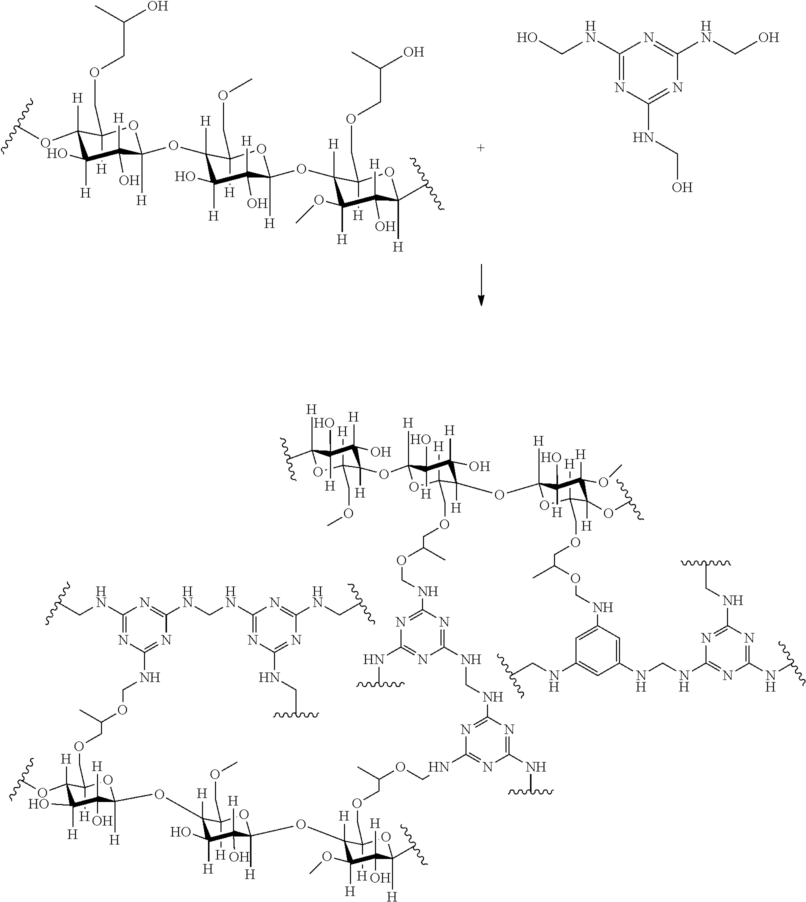

A-5. Other Compounds Thermally Crosslinking with a Hydroxyl Group of the Second Component

Specific examples of compounds thermally crosslinking with the hydroxyl group of the second component, other than the phenolic resin, the amino resin, the epoxy resin and the precursor thereof, include a compound having a (block)isocyanate group, an activated ester group, a carbodiimide group, an acid anhydride and an acid halide. From a viewpoint of improvement of the environmental resistance, the process resistance and the close contact, a compound having a block isocyanate group is preferred. Specific examples include Elastron BN-69, Elastron BN-37, Elastron BN-45, Elastron BN-77, Elastron BN-04, Elastron BN-27, Elastron BN-11, Elastron E-37, Elastron H-3, Elastron BAP, Elastron C-9, Elastron C-52, Elastron F-29, Elastron H-38, Elastron MF-9, Elastron MF-25K, Elastron MC, Elastron NEW BAP-15, Elastron TP-26S, Elastron W-11P, Elastron W-22 and Elastron S-24 (trade name) (Dai-Ichi Kogyo Seiyaku Co., Ltd.).

### B. Compound Having an Alkoxysilyl Group

The compound having the alkoxysilyl group can be used as the third component. The alkoxysilyl group has hydrolysis properties, reacts with moisture and forms a silanol group. Then, the alkoxysilyl group forms a hydrogen bond with a hydroxyl group present on a surface of a substrate such as a glass, a dehydration-condensation reaction occurs by further calcinating the compound, and a siloxane bond being a strong covalent bond is formed between the alkoxysilyl group and the substrate. As a result, the close contact of a film with the substrate after calcination can be increased. A chemical bond uniformly exists wholly between the film and an interface of the substrate, and contributes to an increase in close contact. Moreover, the transparent conductive film of the present invention has one layer, and therefore peeling on the interface of the film does not occur because the chemical bond with the substrate can be formed, which is different from the multilayer transparent conductive film. An increased close contact allows to improve the environmental resistance and the process resistance of the coating.

Moreover, the silanol group forms a siloxane oligomer by a dehydration-condensation reaction with each other during calcination. In the case, physical strength of the film increases because the siloxane oligomer uniformly exists wholly in the film in the first component or the second component. The transparent conductive film of the present invention has one layer, and therefore peeling on the interface of the film does not occur because crosslinking is more uniform, as compared with the multilayer transparent conductive film.

All of the compounds having the alkoxysilyl group may react with the substrate or may be oligomerized. Moreover, a part may react with the substrate, a part may be oligomerized, and a part may be unreacted. Moreover, a plurality of siloxane bonds including a siloxane bond with the substrate, and a siloxane bond with a different compound having the alkoxysilyl group may be formed in one molecule.

As the alkoxysilyl group, a methoxysilyl group, a dimethoxysilyl group, a trimethoxysilyl group, an ethoxysilyl group, a diethoxysilyl group, a triethoxysilyl group, a methyldiethoxysilyl group or an ethyldimethoxysilyl group is preferred in view of reactivity or easiness of industrial procurement. In the case of an alkoxysilyl group having two or more alkoxy groups, a trimethoxysilyl group, a triethoxysilyl group or a methyldiethoxysilyl group is preferred, and a trimethoxysilyl group or a triethoxysilyl group is most preferred because a formed siloxane bond forms a high-dimensional crosslinking structure, and a larger increase in cross contact and physical strength of the film can be expected. Moreover, the compound may have one kind or a plurality of kinds of alkoxysilyl groups, and two or more alkoxysilyl groups in one molecule.

As the compound having the alkoxysilyl group, alkyl alkoxysilanes, alkoxysilazanes, a silane coupling agent, a compound having alkoxysilyl groups at both ends or a precursor thereof can be used, for example. Moreover, the compound can be used in one kind or in a plurality of kinds. As the compound having the alkoxysilyl group used as the third component, a silane coupling agent or a compound having alkoxysilyl groups at both ends is preferred from a viewpoint of reactivity or the like.

### B-1. Silane Coupling Agent

The silane coupling agent is the compound having the alkoxysilyl group and an organic functional group in one molecule. When the silane coupling agent is used as the third component, the close contact of the film to the substrate can be further increased because the organic functional group in the silane coupling agent has affinity with polysaccharides and the derivative thereof as the second component. Specific examples of the organic functional groups include an amino group, a mercapto group, an epoxy group, a vinyl group, a propenyl group and an acrylic group. Among the groups, a compound containing an amino group or an epoxy group is preferred from a viewpoint of a high affinity with the polysaccharides and the derivative thereof, and a silane coupling agent represented by the following general formula (I) or (II) is preferred from a viewpoint of easiness of industrial procurement and reactivity:

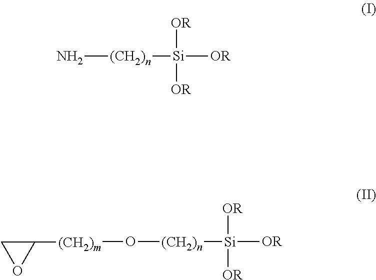

wherein R represents alkyl group having 1 to 3 carbons, and n and m are an integer of 2 to 5.

Furthermore, 3-aminopropyltriethoxysilane or 3-glycidoxypropyltrimethoxysilane is particularly preferred from a viewpoint of the process resistance and the environmental resistance.

As the compound containing the alkoxysilyl group, various kinds of commercial products can be used. Specific examples include Sila-Ace S210, Sila-Ace S220, Sila-Ace S310, Sila-Ace S320, Sila-Ace S330, Sila-Ace S360, Sila-Ace S510, Sila-Ace S520, Sila-Ace S530, Sila-Ace S710, Sila-Ace S810, Sila-Ace S340, Sila-Ace S350 and Sila-Ace XS1003 (trade name) (JNC Corporation), Z-6610, Z-6011, Z-6020, Z-6094, Z-6883, Z-6032, Z-6040, Z-6044, Z-6042, Z-6043, Z-6075, Z-6300, Z-6519, Z-6825, Z-6030, Z-6033, Z-6062, Z-6862, Z-6911, Z-6026, AZ-720 and Z-6050 (trade name) (Dow Corning Toray Co., Ltd.).

### B-2. Compound Having Alkoxysilyl Groups at Both Ends

When using the compound having alkoxysilyl groups at both ends as the third component, a siloxane oligomer having a large molecular weight is formed by the compounds having alkoxysilyl groups with each other during calcination, and thus physical strength of the film can be further increased. The compounds are represented by the following general formula (III), for example:

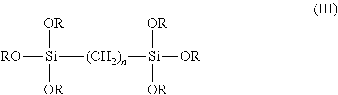

wherein R represents alkyl group having 1 to 3 carbons, and n is an integer of 2 to 5. As R, a methyl group or an ethyl group is preferred in view of reactivity or easiness of industrial procurement, and n is preferably 2 or 3.

From a viewpoint of environmental resistance, process resistance and close contact of the transparent conductive film obtained, content of the third component is preferably in the range of approximately 1.0 part by weight or more to approximately 50 parts by weight or less, further preferably, in the range of approximately 2.5 parts by weight or more approximately to 25 parts by weight or less, still further preferably, in the range of approximately 5.0 parts by weight or more to approximately 15 parts by weight or less based on 100 parts by weight of the second component.

An aspect of a reaction when using 3-aminopropyltriethoxysilane as the third component is shown in the following scheme (2). In the diagram, an aspect of forming a siloxane bond between the substrate and 3-aminopropyltrisilanol produced by hydrolysis of 3-aminopropyltriethoxysilane and between 3-aminopropyltrisilanols is schematically shown. The present invention is not limited to the following scheme (2):

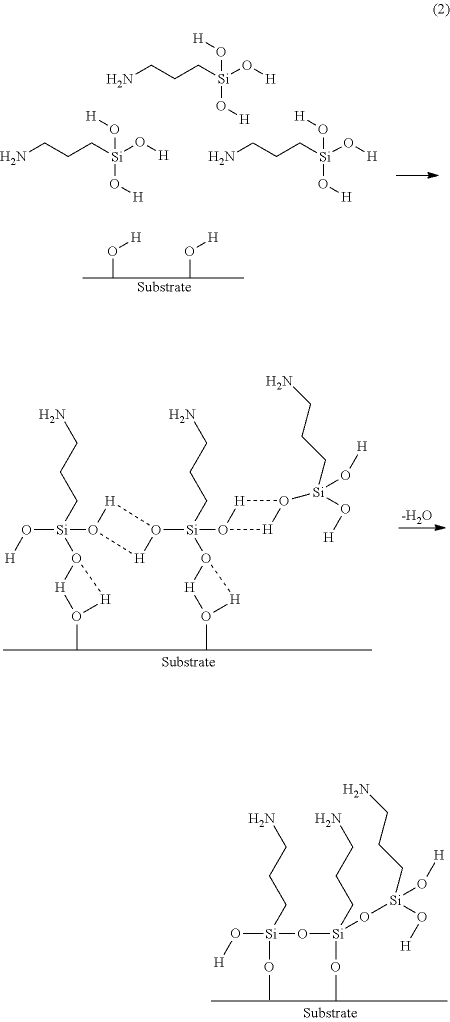

### 1-4. Fourth Component: Water

The coating forming composition of the present invention contains water being the solvent as the fourth component. The fourth component disperses the first component, dissolves the second component and the third component, and simultaneously evaporates during film formation, and thus a film having conductivity is formed. From a viewpoint of controlling viscosity or evaporation rate and dispersibility, the fourth component may contain alcohol, ketone or ether, and a salt of lithium, sodium, potassium, calcium, ammonium or the like, and also an acid or base such as hydrochloric acid and ammonia.

### 1-5. Any Component

The coating forming composition of the present invention may contain any component in the range where properties of the composition are not adversely affected. Specific examples of any of components include a binder component other than the second component, a corrosion inhibitor, a close contact accelerator, a surfactant, a viscosity modifier and an organic solvent.

1-5-1. Binder Component Other than the Second Component

Specific examples of binder components other than the binder components as described in claims include a vinyl compound, such as polyvinyl acetate, polyvinyl alcohol and polyvinyl formal, a biopolymer compound, such as protein, gelatin and polyamino acid, a polyacryloyl compound, such as polymethylmethacrylate, polyacrylate and polyacrylonitrile, a polyester, such as polyethylene terephthalate, polyester naphthalate and polycarbonate, polystyrene, polyvinyl toluene, polyvinyl xylene, polyimide, polyamideimide, polyether imide, polysulfide, polysulfone, polyphenylenes, polyphenyl ether, polyurethane, epoxy (meth)acrylate, melamine (meth)acrylate, a polyolefin such as polypropylene, polymethylpentane, and cyclic olefin, an acrylonitrile-butadiene-styrene copolymer (ABS), silicone resin, polyvinyl chloride, chlorinated polyethylene, chlorinated polypropylene, polyacetate, polynorbornene, synthetic rubber, a fluorinated polymer such as polyfluorovinylidene, polytetrafluoroethylene, polyhexafluoropropylene, a copolymer of fluoroolefin-hydrocarbon olefin and fluorocarbon polymer. However, the binder component is not limited thereto.

### 1-5-2. Corrosion Inhibitor

As the corrosion inhibitor, a specific nitrogen-containing organic compound and a specific sulfur-containing organic compound such as aromatic triazole, imidazole, thiazole and thiol, a biomolecule showing a specific affinity to a metal surface, a compound for blocking a corrosive element by competing with a metal or the like is known. Moreover, metal nanowires may be protected based on a different mechanism by a different corrosion inhibitor.

Specific examples of the corrosion inhibitors include, alkyl-substituted benzotriazole, such as tolyltriazole and butylbenzyltriazole, 2-aminopyrimidine, 5,6-dimethylbenzimidazole, 2-amino-5-mercapto-1,3,4-thiadiazole, 2-mercaptopyrimidine, 2-mercaptobenzoxazole, 2-mercaptobenzothiazole, 2-mercaptobenzimidazole, cysteine, dithiothiadiazole, saturated C6 to C24 linear alkyl dithiothiadiazole, saturated C6 to C24 linear alkylthiol, acrolein, glyoxal, triazine and n-chlorosuccinimide, but not limited thereto. Moreover, the corrosion inhibitor may be used in one kind or in combination of two or more kinds.

### 1-5-3. Surfactant

The coating forming composition of the present invention may contain the surfactant for improving wettability to a base substrate or uniformity of a surface of a hardened film obtained, for example. Specific examples of the surfactants include a silicone surfactant, an acrylic surfactant or a fluorinated surfactant.

Specific examples of commercial products of the surfactants include Zonyl FSO-100, Zonyl FSN, Zonyl FSO and Zonyl FSH (trade name) (E. I. du Pont de Nemours & Co.), Triton X-100, Triton X-114 and Triton X-45 (trade name) (Sigma-Aldrich Japan K.K.), Dynol 604 and Dynol 607 (trade name) (Air Products Japan, Inc.), n-Dodecyl-β-D-maltoside, Novek, Byk-300, Byk-306, Byk-335, Byk-310, Byk-341, Byk-344, Byk-370, Byk-354, Byk-358 and Byk-361 (trade name) (BYK-Chemie Japan K. K.), DFX-18, Futargent 250 and Futargent 251 (trade name) (Neos Co., Ltd.), Megafac F-444, Megafac F-479 and Megafac F-472SF (trade name) (DIC, Inc.). However, the surfactant is not limited thereto. Moreover, the surfactant may be used in one kind or in combination of two or more kinds.

### 1-5-3. Organic Solvent

The coating forming composition of the present invention may contain the organic solvent for the purpose of adjusting compatibility. Specific examples of the organic solvents include methanol, ethanol, isopropanol, butanol or 1-methoxy-2-propanol. However, the organic solvent is not limited thereto. Moreover, the organic solvent may be used alone or by mixing the organic solvents.

### Composition and Physical Properties of the Coating Forming Composition

From a viewpoint of a favorable dispersibility of each component in the composition, and a high conductivity, a favorable optical transparency, a favorable environmental resistance, a favorable process resistance and a favorable close contact of the coating obtained from the composition of the present invention, content of each component in the coating forming composition of the present invention is preferably in the range of approximately 0.01% by weight or more to approximately 1.0% by weight or less for the first component based on the total weight of the coating forming composition, in the range of approximately 50 parts by weight or more to approximately 300 parts by weight or less for the second component based on 100 parts by weight of the first component and in the range of approximately 1.0 part by weight or more to approximately 50 parts by weight or less for the third component based on 100 parts by weight of the second component, further preferably, in the range of approximately 0.05% by weight or more to approximately 0.75% by weight or less for the first component based on the total weight of the coating forming composition, in the range of approximately 75 parts by weight or more to approximately 250 parts by weight or less for the second component based on 100 parts by weight of the first component and in the range of approximately 2.5 parts by weight or more to approximately 25 parts by weight or less for the third component based on 100 parts by weight of the second component, still further preferably, in the range of approximately 0.1% by weight or more to approximately 0.5% by weight or less for the first component based on the total weight of the coating forming composition, in the range of approximately 100 parts by weight or more to approximately 200 parts by weight or less for the second component based on 100 parts by weight of the first component and in the range of approximately 5.0 parts by weight or more to approximately 15 parts by weight or less for the third component based on 100 parts by weight of the second component.

More specifically, based on the total amount of the first component to the fourth component, the composition of each component is preferably in the range of approximately 0.01% by weight or more to approximately 1.0% by weight or less for the first component, in the range of approximately 0.005% by weight or more to approximately 3.0% by weight or less for the second component, in the range of approximately 0.00005% by weight or more to approximately 1.5% by weight or less for the third component and in the range of approximately 94.5% by weight or more to approximately 99.9395% by weight or less for the fourth component, further preferably, in the range of approximately 0.05% by weight or more to approximately 0.75% by weight or less for the first component, in the range of approximately 0.0375% by weight or more to approximately 1.875% by weight or less for the second component, in the range of approximately 0.0009375% by weight or more to approximately 0.46875% by weight or less for the third component and in the range of approximately 96.90625% by weight or more to approximately 99.9115625% by weight or less for the fourth component, still further preferably, in the range of approximately 0.1% by weight or more to approximately 0.5% by weight or less for the first component, in the range of approximately 0.1% by weight or more to approximately 1.0% by weight or less for the second component, in the range of approximately 0.005% by weight or more to approximately 0.15% by weight or less for the third component and in the range of approximately 98.35% by weight or more to approximately 99.795% by weight or less for the fourth component.

The coating forming composition of the present invention can be manufactured by appropriately selecting agitating, mixing, heating, cooling, dissolving, dispersing or the like of the components as described above according to a known method.

As a viscosity of the coating forming composition of the present invention is higher, precipitation of the metal nanowires and the metal nanotubes is suppressed, and a more uniform dispersibility is obtained for a long period of time. Moreover, as the viscosity is higher, a film having a higher conductivity can be obtained because film thickness can be increased under fixed application conditions. On the other hand, as the viscosity is lower, smoothness and uniformity of the coating is better. Thus, the viscosity at 25° C. of the coating forming composition of the present invention is preferably in the range of approximately 1 mPa·s or more to approximately 100 mPa·s or less, further preferably, in the range of approximately 10 mPa·s or more to approximately 70 mPa·s or less. In the present invention, the viscosity is a value measured by using a cone plate type rotational viscometer.

### Method for Manufacturing a Substrate Having a Transparent Conductive Film

The substrate having the transparent conductive film can be manufactured by using the coating forming composition of the present invention. The method for manufacturing the substrate includes a process for forming the coating on the substrate by applying the composition on the substrate, and then heating the substrate at temperature in the range of approximately 30° C. or higher to 80° C. or lower, and subsequently calcinating the substrate at temperature in the range of approximately 120° C. or higher to 240° C. or lower.

The coating having the conductivity, the environmental resistance and the process resistance is formed on the substrate by applying the composition onto the substrate, and then removing the solvent.

As the substrate, properties may be rigid or flexible or colored. Specific examples of the materials of the substrate include glass, polyimide, polycarbonate, polyethersulfone, acryloyl, polyester, polyethylene terephthalate, polyethylene naphthalate, polyolefin and polyvinyl chloride. The materials preferably have a high light transmittance and a low haze value. Furthermore, a circuit such as a TFT element may be preferably formed on the substrate or an organic functional material such as a color filter and an overcoat, or an inorganic functional material such as a silicon nitride or silicon oxide film may be formed thereon. Moreover, a number of the substrates may be laminated.

As a method for applying the composition of the present invention to the substrate, a general method such as a spin coating method, a slit coating method, a dip coating method, a blade coating method, a spray method, a relief printing method, an intaglio printing method, a planographic printing method, a dispensing method and an ink jet method can be used. From a viewpoint of the uniformity of the film thickness and productivity, the spin coating method and the slit coating method are preferred, and the slit coating method is further preferred.

Surface resistance is determined depending on an application.

The surface resistance is determined depending on the film thickness and surface density of the first component. The film thickness and the surface density of the first component are determined depending on viscosity and a concentration of the first component in the coating forming composition. The film thickness is determined depending on application conditions. Accordingly, a desired surface resistance is controlled by the viscosity and the concentration of the first component in the coating forming composition.

A larger film thickness is better from a viewpoint of a low surface resistance, and a smaller film thickness is better from a viewpoint of suppressing occurrence of a poor display due to a step. Therefore, when comprehensively taking the facts into consideration, the film thickness is preferably in the range of approximately 5 nanometers to approximately 500 nanometers, further preferably, in the range of approximately 5 nanometers to approximately 200 nanometers, still further preferably, in the range of approximately 5 nanometers to approximately 100 nanometers.

The solvent is removed by performing heating treatment of an applied article when necessary. As heating temperature, heating is ordinarily performed at temperature in the range of approximately 30° C. to approximately a boiling point of the solvent plus 50° C., although the range is different depending on kinds of solvents.

The surface resistance and the total transmittance of the film obtained can be adjusted to a desired value by adjusting the film thickness or an applied amount of the composition, conditions of the method of application, and the concentration of the first component in the coating forming composition of the present invention.

In general, as the film thickness is larger, the surface resistance and the total transmittance are decreased. Moreover, as the concentration of the first component in the coating forming composition is higher, the surface resistance and the total transmittance are decreased.

The coating obtained as described above has preferably a surface resistance in the range of approximately 1 Ω/□ or more to approximately 10,000 Ω/□ or less and a total transmittance of approximately 80% or more, further preferably, a surface resistance in the range of approximately 10 Ω/□ or more to approximately 5,000 Ω/□ or less and a total transmittance of approximately 85% or more.

In the present invention, the surface resistance refers to a measured value according to a noncontact measurement method as described later, unless otherwise noted.

### Patterning of a Transparent Conductive Film

Patterning of the transparent conductive film prepared according to the present invention can be performed according to the application. As the method, a photolithographic method using a resist material generally used for patterning of ITO can be applied. Procedures of the photolithographic method are shown below.

(1) Resist application

### (2) Calcination

### (3) Exposure

### (4) Development

### (5) Etching

### (6) Peeling

### Any Process

Before and after each process of film formation and patterning of the composition described above, a suitable treatment process, a suitable cleaning process and a suitable drying process may be appropriately applied. Specific examples of the treatment processes include a plasma surface treatment, an ultrasonic treatment, an ozone treatment and a cleaning process using a suitable solvent and a heat treatment. Moreover, a process for immersing into water may be applied. Thus, immersing into water is preferred from a viewpoint of a low surface resistance.

The plasma surface treatment can be applied for improving applicability of the coating forming composition or a developer. For example, the surface of the substrate or the coating forming composition on the substrate can be treated under conditions of 100 W, 90 seconds, an oxygen flow rate of 50 sccm (sccm; standard cc/min) and a pressure of 50 Pa by using oxygen plasma. According to the ultrasonic treatment, particulates physically deposited or the like on the substrate can be removed by immersing the substrate into a solution, and propagating an ultrasonic wave about 200 kHz, for example. According to the ozone treatment, a deposit or the like on the substrate can be effectively removed by blowing air to the substrate and simultaneously irradiating the substrate with an ultraviolet light and utilizing oxidizing power of ozone generated by the ultraviolet light. According to the cleaning treatment, a particulate impurity can be washed out and removed by spraying pure water in a mist form or a shower form and utilizing dissolving capability and pressure of the pure water, for example. The heat treatment is a method for removing a compound to be desirably removed in the substrate by volatilizing the compound. Heating temperature is appropriately set up in consideration of a boiling point of the compound to be desirably removed. For example, when the compound to be desirably removed is water, the substrate is heated at temperature in the range of approximately 50° C. to about 80° C.

The surface resistance and the total transmittance of the transparent conductive film on the substrate having a transparent conductive film subjected to patterning as obtained according to the manufacturing method as described above has preferably a surface resistance in the range of approximately 1 Ω/□ or more to approximately 10,000 Ω/□ or less and a total transmittance of approximately 80% or more, further preferably, a surface resistance in the range of approximately 10 Ω/□ or more to approximately 5,000 Ω/□ or less and a total transmittance of approximately 85% or more.

Herein, “total transmittance” is a ratio of transmitted light to an incident light, and the transmitted light includes a directly transmitted component and a scattered component. A light source is illuminant C and a spectrum is a CIE luminosity function y. Moreover, the film thickness is preferably in the range of approximately 5 nanometers or more to approximately 100 nanometers or less, further preferably, in the range of approximately 10 nanometers or more to approximately 80 nanometers or less, still further preferably, in the range of approximately 20 nanometers or more to approximately 80 nanometers or less, although the film thickness is different according to the application.

Such surface resistance and total transmittance can be adjusted to a desired value by adjusting the film thickness or an applied amount of the composition, and conditions of the method of application, and the concentration of the first component in the coating forming composition of the present invention.

As for the transparent conductive film subjected to patterning, an insulating film, an overcoat having a protective function or a polyimide layer having an orientation function can be further arranged on the surface thereof.

### Application of the Substrate Having the Transparent Conductive Film Subjected to Patterning

The substrate having the transparent conductive film subjected to patterning is used for a device element from conductivity and optical properties thereof.

Specific examples of the device elements include a liquid crystal display element, an organic electroluminescence element, an electronic paper, a touch panel element and a photovoltaic cell element.

The device element may be prepared by using a rigid substrate or a flexible substrate or the combination thereof. Moreover, the substrate used for the device element may be transparent or colored.

Specific examples of the transparent conductive films used for the liquid crystal display element include a picture element electrode to be formed on a side of a thin film transistor (TFT) array substrate and a common electrode formed on a side of a color filter substrate. Specific examples of display modes of LCD include Twisted Nematic (TN), Multi Vertical Alignment (MVA), Patterned Vertical Alignment (PVA), In Plane Switching (IPS), Fringe Field Switching (FFS), Polymer Stabilized Vertical Alignment (PSA), Optically Compensated Bend (OCB), Continuous Pinwheel Alignment (CPA) and Blue Phase (BP). Moreover, a transmissive type, a reflective type and a transreflecive type are provided for each of the modes. The picture element electrode of LCD is subjected to patterning for each picture element, and is electrically connected to a drain electrode of TFT. In addition, the IPS mode has a comb electrode structure, and the PVA mode has structure in which slits are curved in the picture element, for example.

The transparent conductive film used for the organic electroluminescence element is ordinarily subjected to patterning in a stripe on the substrate, when the film is used as a conductive region of a passive type driving mode. A direct current voltage is applied between the conductive region in the stripe (anode) and a conductive region in a stripe arranged orthogonally thereto (cathode), and thus display is conducted by allowing picture elements in the matrix to emit light. When the film is used as an electrode of an active type driving mode, the film is subjected to patterning on the side of the TFT array substrate for each picture element.

The touch panel element includes a resistive type and a capacitive type depending on the detection method, and a transparent electrode is used for any of the types. The transparent electrode used for the capacitive type is subjected to patterning.

The electronic paper includes a microcapsule type, a quick response liquid powder type, a liquid crystal type, an electrowetting type, an electrophoretic type and a chemical reaction change type depending on the display method, and the transparent electrode is used for any of the types. The transparent electrode is subjected to patterning into any shape, respectively.

The photovoltaic cell element includes a silicon type, a compound type, an organic type and a quantum dot type depending on a material of an optical absorption layer, and the transparent electrode is used for any of the types. The transparent electrode is subjected to patterning in any shape, respectively.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

In the following, the present invention will be further specifically explained based on Examples, but the present invention is not limited to the Examples. In Examples and Comparative Examples, ultrapure water was used as water being a constituent. However, ultrapure water may be referred to simply as water in the following. Preparation was performed using Puric FPC-0500-0M0 (trade name) (Organo Corporation) as ultrapure water.

Measurement methods or evaluation methods in each evaluation item were applied according to the following methods.

Unless otherwise noted, measurements (1) to (4) were carried out in a region in which a transparent conductive film of a sample to be evaluated is formed.

### (1) Measurement of Surface Resistance

As the evaluation method, two kinds of a four-point probe method and a noncontact measurement method were applied.

Loresta-GPMCP-T610 (Mitsubishi Chemical Corporation) was used for the four-point probe measurement method (in accordance with JIS K7194). A probe used for measurement is a proprietary ESP type probe having a distance of 5 millimeters between pins, and a pin point diameter of 2 millimeters. Surface resistance (Ω/□) was calculated by bringing the probe into contact with the sample to be evaluated, measuring a potential difference between inside two terminals when applying a fixed current to outside two terminals, and multiplying resistance obtained by the measurement by a correction coefficient. Volume resistivity (Q·cm) and conductivity (Siemens/cm) can be determined from the thus obtained surface resistance value and thickness of a conductive film.

According to the four-point probe measurement method, surface resistance of the conductive film on the substrate in which at least one insulating film was formed on the conductive film, and surface resistance of the conductive film in which metal nanowires or metal nanotubes as shown in the specification were dispersed into an insulator cannot be stably measured sometimes. In the case, a noncontact surface resistance measurement method using an eddy current was applied. As the noncontact measurement method, surface resistance (Ω/□) was measured using 717 B-H (DELCOM). Also in the case, volume resistivity (Q·cm) and conductivity (Siemens/cm) can be determined from the thus obtained surface resistance value and thickness of the conductive film. In addition, a measured value according to the four-point probe method and a measured value according to the noncontact measurement method agree substantially. The noncontact measurement method was used, unless otherwise noted.

### (2) Measurement of Total Transmittance and Haze

Haze-gard plus (BYK Gardner, Inc.) was used for measurement of total transmittance and haze. Air was used as a reference.

### (3) Film Thickness

Profilometer P-16+ (KLA-Tencor) was used for measurement of film thickness.

The film thickness was measured in accordance with “Test method for thickness of fine ceramic thin films—Film thickness by contact probe profilometer” (JIS R1636). When measuring film thickness of a film not subjected to patterning, a part of films of a sample to be evaluated was shaved off, and a profile on a boundary surface was measured.

### (4) Testing of Environmental Resistance

Environmental resistance was evaluated by leaving a transparent conductive film to stand in a constant temperature oven at 70° C., and a high temperature and high humidity oven at 70° C. and 90% RH, measuring total transmittance and haze after 500 hours, and comparing a measured value with an initial value.

When comparing the surface resistance and the total transmittance and the haze with the initial value in terms of a rate of change, evaluation results were determined to be good when the rate of change of all of the properties are in the range of 0% or more to 50% or less, marginal when the rate of change of at least one of the properties is in the range of 51% or more to 100% or less, and bad when the rate of change of at least one of the properties is in the range of 101% or more.

### (5) Testing of Process Resistance

Water was sprayed to a sample to be evaluated at a pressure of 270 kPa for 1 or 5 minutes by using Developer EX-25D (Yoshitani Shokai K. K). Process resistance was evaluated by performing (a) visual inspection of presence or absence of film peeling, (b) measurement of surface resistance, and (c) measurement of total transmittance and haze before and after spraying.

The film was visually observed, and evaluation results were determined to be good when no peeling of the film was observed under conditions of 270 kPa for 1 minute, marginal when peeling was observed in an area of 1% or more to less than 50% of the substrate, and bad when peeling was observed in an area of 50% or more to 100% or less of the substrate. A sample determined to be good according to the evaluation results was evaluated under conditions of 270 kPa for 5 minutes, and when no peeling of the film was observed, the sample was determined to be excellent.

### (6) Measurement of Viscosity of a Composition

As for a viscosity of a composition used in Examples, viscosity when temperature was 25° C. and a shear rate was 100 s⁻¹ was measured using TV-22 viscometer (Toki Sangyo Co., Ltd.).

### (7) Testing of Dispersion Stability of a Composition (Dispersibility)

After putting 10 g of a composition used in Examples in a screw vial of 20 mL and sufficiently shaking the vial up, the vial was left to stand for one week under room temperature. Precipitation of silver nanowires after leaving the vial to stand was visually confirmed. A composition where no precipitation of silver nanowires was observed was determined to be good, a composition where contrasting density was observed to be marginal, and a composition where precipitation of silver nanowires was observed in the bottom of the screw vial to be bad.

### (8) Testing of Close Contact

A cross cut test was performed using 3M396 tape (trade name) (Sumitomo 3M Co., Ltd.), and the number of residues after tape peeling in 100 cross cuts having a size of 1 mm×1 mm was evaluated. A tape where no peeling was observed was determined to be good, a tape where peels of 1 or more to less than 50 were observed to be marginal, and a tape where peels of 50 or more to 100 or less were observed to be bad.

The first component (metal nanowires or metal nanotubes) used in the present invention was prepared as described below.

### Preparation of Silver Nanowires

A reaction mixture containing silver nanowires was obtained by putting 4.171 g of poly(N-vinylpyrrolidone) (trade name; Polyvinylpyrrolidone K30, MW 40,000, Tokyo Kasei Kogyo Co., Ltd.), 70 mg of tetrabuthylammonium chloride (trade name; Tetrabuthylammonium chloride, Wako Pure Chemical Industries, Ltd.), 4.254 g of silver nitrate (trade name; Silver nitrate, Wako Pure Chemical Industries, Ltd.) and 500 mL of ethylene glycol (trade name; Ethylene glycol, Wako Pure Chemical Industries, Ltd.) in a 1,000 mL flask, agitating the mixture for 15 minutes and uniformly dissolving the mixture, and agitating the mixture at 110° C. for 16 hours in an oil bath.

Subsequently, the reaction mixture was returned to room temperature (25 to 30° C.), and then a reaction solvent was replaced to water with a centrifuge (As One Corporation), and thus aqueous silver nanowires dispersion solution I having any concentration was obtained. According to the operation, unreacted silver nitrate, poly(N-vinylpyrrolidone) used as a mold, tetrabuthylammonium chloride, ethylene glycol and silver nanoparticles having a small particle size in the reaction mixture were removed. An aqueous silver nanowires dispersion solution having any concentration was obtained by redispersing precipitates on a filter paper into water. Mean values of a minor axis, a major axis and an aspect ratio of the silver nanowires were 68 nanometers, 18 micrometers and 265, respectively.

A binder solution being the second component (polysaccharides and the derivative thereof) used in the present invention was prepared as described below.

### Preparation of Binder Solution I

In a 300 mL beaker whose tare weight was premeasured, 100 g of ultrapure water was put, and heated and agitated. At a liquid temperature of 80 to 90° C., 2.00 g of hydroxypropyl methyl cellulose (abbreviated as HPMC, trade name; Metolose 60SH-10000, Shin-Etsu Chemical Co., Ltd., 10,000 mPa·s in viscosity of a 2 wt. % aqueous solution) was put in the beaker little by little, and agitated strongly to disperse HPMC uniformly. While keeping strong agitation, 80 g of ultrapure water was added, and simultaneously heating was stopped, and agitation was continued while cooling the beaker with ice water until a uniform solution was formed. After agitation for 20 minutes, ultrapure water was added for weight of an aqueous solution to be 200.00 g, and agitation was continued for further 10 minutes at room temperature until a uniform solution was formed, and thus 1 wt. % aqueous HPMC solution I was prepared.

Then 0.8 wt. % binder solution I was prepared by measuring 32.00 g of 1 wt. % HPMC solution I, 3.20 g of 0.1 wt. % aqueous TritonX-100 (trade name) (Sigma-Aldrich Japan, Inc.) solution and 4.80 g of ultrapure water, and agitating the mixture until a uniform solution was formed.

### Preparation of Binder Solution II

Then 0.8 wt. % binder solution II was prepared in a manner similar to preparation of binder solution I except that hydroxypropyl methyl cellulose was changed to a large molecular weight product (trade name; Metolose 90SH-100000, Shin-Etsu Chemical Co., Ltd., 100,000 mPa·s in viscosity of a 2 wt. % aqueous solution).

### Preparation of Binder Solution III

Then 0.8 wt. % binder solution III was prepared by performing operation in a manner similar to preparation of binder solution I except that hydroxypropyl methyl cellulose was changed to a smaller molecular weight product (trade name; (Hydroxypropyl)methyl cellulose, Aldrich Corporation, 4,000 mPa·s in viscosity of a 2 wt. % aqueous solution).

### Preparation of Binder Solution IV

Then 0.8 wt. % binder solution IV was prepared by performing operation in a manner similar to preparation of binder solution I except that hydroxypropyl methyl cellulose was changed to a larger molecular weight product (trade name; Metolose SHV-PF, 200,000 mPa·s in viscosity of a 2 wt. % aqueous solution).

### Example 1

### Preparation of Aqueous Polymer Solution I (Third Component)

Then 1.0 wt. % aqueous polymer solution I was prepared by measuring 0.10 g of Riken Resin MM-35 (trade name; Methylol Melamine Resin, Miki Riken Industrial Co., Ltd.) having a solids concentration of 80% by weight and 22.9 mg of Riken Fixer RC-3 (trade name) (catalyst, Miki Riken Industrial Co., Ltd.) having a solids concentration of 35% by weight, and diluting the mixture with 7.88 g of ultrapure water.

### Preparation of a Coating Forming Composition

Then 4.00 g of 0.8 wt. % binder solution I, 1.60 g of 1.0 wt. % aqueous silver nanowires dispersion solution I and 2.08 g of ultrapure water were measured and agitated until a uniform solution was formed. Subsequently, 0.32 g of aqueous polymer solution I having a solid content of 1.0% by weight was added and agitated until a uniform solution was formed, and thus a coating forming composition having the following composition was obtained. The prepared coating forming composition had a viscosity of 15 mPa·s, and showed a favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC-3 | 0.004 | % by weight |
| Triton X-100 | 0.004 | % by weight |
| Water | 99.352 | % by weight |

In addition, HPMC corresponded to 200 parts by weight based on 100 parts by weight of silver nanowires, Riken Resin MM-35 corresponded to 10 parts by weight based on 100 parts by weight of HPMC, and Riken Fixer RC-3 corresponded to 10 parts by weight based on 100 parts by weight of Riken Resin MM-35.

### Preparation of a Transparent Conductive Film

On a surface of 0.7 mm-thick Eagle XG (trade name) (Corning, Inc.) glass substrate subjected to UV ozone treatment with being irradiated at an irradiation energy of 1,000 mJ/cm² (low pressure mercury lamp (254 nanometers)), 1 mL of the coating forming composition obtained was dropped, and spin coating was performed at 800 rpm using a spin coater (trade name; MS-A150, Mikasa Inc.). Preliminary calcination was performed on the glass substrate on a hot stage at 50° C. under conditions for 90 seconds, and then major calcination was performed for 3 minutes on a hot stage at 140° C., and thus a transparent conductive film was prepared.

### Evaluation of the Transparent Conductive Film

The transparent conductive film obtained had a surface resistance value of 47.4 Ω/□, a total transmittance of 91.4%, a haze of 1.6% and a film thickness of 35 nanometers. Moreover, environmental resistance, process resistance and close contact were favorable. Furthermore, the environmental resistance, the process resistance and the close contact were favorable also on silicon nitride and an overcoat (product name; PIG-7424, JNC Corporation).

The evaluation results were shown in Table 1. In addition, only an evaluation using a glass was summarized in the table.

### Example 2

A coating forming composition having the following composition was prepared according to procedures similar to Example 1 except that an amount of 1.0 wt. % aqueous Riken Resin MM-35 solution was changed to 0.080 g. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.01 | % by weight |
| Riken Fixer RC-3 | 0.001 | % by weight |
| Triton X-100 | 0.004 | % by weight |
| Water | 99.385 | % by weight |

In addition, HPMC corresponded to 200 parts by weight based on 100 parts by weight of silver nanowires, Riken Resin MM-35 corresponded to 2.5 parts by weight based on 100 parts by weight of HPMC, and Riken Fixer RC-3 corresponded to 10 parts by weight based on 100 parts by weight of Riken Resin MM-35.

A transparent conductive film was prepared according to procedures similar to Example 1. The transparent conductive film obtained had a surface resistance value of 43.9 Ω/□, a total transmittance of 91.3% and a haze of 1.6%. Moreover, environmental resistance and process resistance were favorable.

### Example 3

A coating forming composition having the following composition was prepared according to procedures similar to Example 1 except that an amount of 1.0 wt. % aqueous Riken Resin MM-35 solution was changed to 1.28 g. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.16 | % by weight |
| Riken Fixer RC-3 | 0.016 | % by weight |
| Triton X-100 | 0.004 | % by weight |
| Water | 99.220 | % by weight |

In addition, HPMC corresponded to 200 parts by weight based on 100 parts by weight of silver nanowires, Riken Resin MM-35 corresponded to 40 parts by weight based on 100 parts by weight of HPMC, and Riken Fixer RC-3 corresponded to 10 parts by weight based on 100 parts by weight of Riken Resin MM-35.

A transparent conductive film was prepared according to procedures similar to Example 1 except that spin coating was performed at 500 rpm. The transparent conductive film obtained had a surface resistance value of 103 Ω/□, a total transmittance of 89.3% and a haze of 2.3%. Moreover, environmental resistance and process resistance were favorable.

### Example 4

A coating forming composition having the following composition was prepared according to procedures similar to Example 1 except that a binder solution used was changed to 4.00 g of 0.8 wt. % binder solution II. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC-3 | 0.004 | % by weight |
| Triton X-100 | 0.004 | % by weight |
| Water | 99.352 | % by weight |

In addition, HPMC corresponded to 200 parts by weight based on 100 parts by weight of silver nanowires, Riken Resin MM-35 corresponded to 10 parts by weight based on 100 parts by weight of HPMC, and Riken Fixer RC-3 corresponded to 10 parts by weight based on 100 parts by weight of Riken Resin MM-35.

A transparent conductive film was prepared according to procedures similar to Example 1 except that spin coating was performed at 1,000 rpm. The transparent conductive film obtained had a surface resistance value of 30.8 Ω/□, a total transmittance of 91.2% and a haze of 1.7%. Moreover, environmental resistance and process resistance were favorable.

### Example 5

A coating forming composition having the following composition was prepared according to procedures similar to Example 4 except that 3.20 g of 0.1 wt. % Futargent 251 (trade name) (Neos Co., Ltd.) was used in place of 3.20 g of 0.1 wt. % aqueous Triton X-100 solution. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC-3 | 0.004 | % by weight |
| Futargent 251 | 0.004 | % by weight |
| Water | 99.352 | % by weight |

In addition, HPMC corresponded to 200 parts by weight based on 100 parts by weight of silver nanowires, Riken Resin MM-35 corresponded to 10 parts by weight based on 100 parts by weight of HPMC, and Riken Fixer RC-3 corresponded to 10 parts by weight based on 100 parts by weight of Riken Resin MM-35.

A transparent conductive film was prepared according to procedures similar to Example 4. The transparent conductive film obtained had a surface resistance value of 29.8 Ω/□, a total transmittance of 91.2% and a haze of 1.8%. Moreover, environmental resistance and process resistance were favorable.

### Example 6

A coating forming composition having the following composition was prepared according to procedures similar to Example 1 except that a binder solution used was changed to 4.00 g of 0.8 wt. % binder solution III. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC-3 | 0.004 | % by weight |
| Triton X-100 | 0.004 | % by weight |
| Water | 99.352 | % by weight |

In addition, HPMC corresponded to 200 parts by weight based on 100 parts by weight of silver nanowires, Riken Resin MM-35 corresponded to 10 parts by weight based on 100 parts by weight of HPMC, and Riken Fixer RC-3 corresponded to 10 parts by weight based on 100 parts by weight of Riken Resin MM-35.

A transparent conductive film was prepared according to procedures similar to Example 1 except that spin coating was performed at 800 rpm. The transparent conductive film obtained had a surface resistance value of 60.3Ω/□, a total transmittance of 92.0% and a haze of 1.3%. Moreover, environmental resistance and process resistance were favorable.

### Example 7

A coating forming composition having the following composition was prepared according to a composition and procedures similar to Example 1 except that a binder solution used was changed to 4.00 g of 0.8 wt. % binder solution IV. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC-3 | 0.004 | % by weight |
| Triton X-100 | 0.004 | % by weight |
| Water | 99.352 | % by weight |

In addition, HPMC corresponded to 200 parts by weight based on 100 parts by weight of silver nanowires, Riken Resin MM-35 corresponded to 10 parts by weight based on 100 parts by weight of HPMC, and Riken Fixer RC-3 corresponded to 10 parts by weight based on 100 parts by weight of Riken Resin MM-35.

A transparent conductive film was prepared according to procedures similar to Example 1 except that spin coating was performed at 2,000 rpm. The transparent conductive film obtained had a surface resistance value of 33.8 Ω/□, a total transmittance of 91.8% and a haze of 1.3%. Moreover, environmental resistance and process resistance were favorable.

### Example 8

### Preparation of Aqueous Polymer Solution VI (Third Component)

Thus, 1.0 wt. % aqueous polymer solution VI was prepared by measuring 0.10 g of Riken Resin MA-156 (trade name) (methylol melamine resin, Miki Riken Industrial Co., Ltd.) having a solids concentration of 80% and 25.8 mg of Riken Fixer RC (trade name) (catalyst, Miki Riken Industrial Co., Ltd.) having a solids concentration of 31%, and diluting the mixture with 7.87 g of ultrapure water.

### Preparation of a Coating Forming Composition

A coating forming composition having the following composition was prepared according to procedures similar to Example 1 except that 1.0 wt. % aqueous polymer solution VI was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Riken Resin MA-156 | 0.04 | % by weight |
| Riken Fixer RC | 0.004 | % by weight |
| Triton X-100 | 0.004 | % by weight |
| Water | 99.352 | % by weight |

In addition, HPMC corresponded to 200 parts by weight based on 100 parts by weight of silver nanowires, Riken Resin MA-156 corresponded to 10 parts by weight based on 100 parts by weight of HPMC, and Riken Fixer RC corresponded to 10 parts by weight based on 100 parts by weight of Riken Resin MA-156.

A transparent conductive film was prepared according to procedures similar to Example 1. The transparent conductive film obtained had a surface resistance value of 51.1 Ω/□, a total transmittance of 91.3% and a haze of 1.6%. Moreover, environmental resistance and process resistance were favorable.

### Example 9

### Preparation of Aqueous Polymer Solution VII (Third Component)

Then, 1.0 wt. % aqueous polymer solution VII was prepared by measuring 0.10 g of Riken Resin MM-35 having a solids concentration of 80 wt. % and 25.8 mg of Riken Fixer RC (trade name) (Miki Riken Industrial Co., Ltd.) having a solids concentration of 31 wt. %, and diluting the mixture with 7.87 g of ultrapure water.

### Preparation of a Coating Forming Composition

A coating forming composition having the following composition was prepared according to procedures similar to Example 1 except that 1.0 wt. % aqueous polymer solution VII was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC | 0.004 | % by weight |
| Triton X-100 | 0.004 | % by weight |
| Water | 99.352 | % by weight |

In addition, HPMC corresponded to 200 parts by weight based on 100 parts by weight of silver nanowires, Riken Resin MM-35 corresponded to 10 parts by weight based on 100 parts by weight of HPMC, and Riken Fixer RC corresponded to 10 parts by weight based on 100 parts by weight of Riken Resin MM-35.

A transparent conductive film was prepared according to procedures similar to Example 1. The transparent conductive film obtained had a surface resistance value of 52.8 Ω/□, a total transmittance of 91.2% and a haze of 1.5%. Moreover, environmental resistance and process resistance were favorable.

### Example 10

### Preparation of Aqueous Polymer Solution VIII (Third Component)

Then, 1.0 wt. % aqueous polymer solution VIII was prepared by measuring 0.10 g of Riken Resin MA-156 having a solids concentration of 80 wt. % and 22.9 mg of Riken Fixer RC-3 having a solids concentration of 35 wt. %, and diluting the mixture with 7.87 g of ultrapure water.

### Preparation of a Coating Forming Composition

A coating forming composition having the following composition was prepared according to procedures similar to Example 1 except that 1.0 wt. % aqueous polymer solution VIII was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Riken Resin MA-156 | 0.04 | % by weight |
| Riken Fixer RC-3 | 0.004 | % by weight |
| Triton X-100 | 0.004 | % by weight |
| Water | 99.352 | % by weight |

In addition, HPMC corresponded to 200 parts by weight based on 100 parts by weight of silver nanowires, Riken Resin MA-156 corresponded to 10 parts by weight based on 100 parts by weight of HPMC, and Riken Fixer RC-3 corresponded to 10 parts by weight based on 100 parts by weight of Riken Resin MA-156.

A transparent conductive film was prepared according to procedures similar to Example 1. The transparent conductive film obtained had a surface resistance value of 54.0 Ω/□, a total transmittance of 91.4% and a haze of 1.5%. Moreover, environmental resistance and process resistance were favorable.

### Example 11

### Preparation of Aqueous Polymer Solution IX

Then, 1.0 wt. % aqueous polymer solution IX was prepared by measuring 0.264 g of Sumirez 633 (trade name) (having an epoxy group, Taoka Chemical Co., Ltd.) having a solids concentration of 30% by weight and diluting the mixture with 7.75 g of ultrapure water.

### Preparation of a Coating Forming Composition

A coating forming composition having the following composition was prepared according to procedures similar to Example 1 except that 1.0 wt. % aqueous polymer solution IX was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Sumirez 633 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Sumirez 633 corresponded to 10 parts by weight based on 100 parts by weight of HPMC.

A transparent conductive film was prepared according to procedures similar to Example 1. The transparent conductive film obtained had a surface resistance value of 31.4 Ω/□, a total transmittance of 90.4% and a haze of 2.4%. Moreover, environmental resistance and process resistance were favorable.

### Example 12

### Preparation of Aqueous Polymer Solution X

Then, 1.0 wt. % aqueous polymer solution X was prepared by measuring 1.16 g of Elastron BN-11 (trade name) (having an isocyanate group, Dai-Ichi Kogyo Seiyaku Co., Ltd.) having a solids concentration of 34.5% by weight and diluting the mixture with 6.84 g of ultrapure water.

### Preparation of a Coating Forming Composition

A coating forming composition having the following composition was prepared according to procedures similar to Example 1 except that 1.0 wt. % aqueous polymer solution X was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Elastron BN-11 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Elastron B-11 corresponded to 10 parts by weight based on 100 parts by weight of HPMC.

A transparent conductive film was prepared according to procedures similar to Example 1. The transparent conductive film obtained had a surface resistance value of 36.0 Ω/□, a total transmittance of 91.1% and a haze of 5.9%. Moreover, environmental resistance and process resistance were favorable.

### Example 13

### Preparation of Aqueous Polymer Solution XI

Then, 1.0 wt. % aqueous polymer solution XI was prepared by measuring 1.75 g of Elastron H-3 (trade name) (having an isocyanate group, Dai-Ichi Kogyo Seiyaku Co., Ltd.) having a solids concentration of 22.9% by weight and diluting the mixture with 6.25 g of ultrapure water.

### Preparation of a Coating Forming Composition

A coating forming composition having the following composition was prepared according to procedures similar to Example 1 except that 1.0 wt. % aqueous polymer solution XI was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Elastron H-3 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Elastron H-3 corresponded to 10 parts by weight based on 100 parts by weight of HPMC.

A transparent conductive film was prepared according to procedures similar to Example 1. The transparent conductive film obtained had a surface resistance value of 25.7 Ω/□, a total transmittance of 88.3% and a haze of 3.8%. Moreover, environmental resistance and process resistance were favorable.

### Example 14

### Preparation of Aqueous Polymer Solution XII

Then, 1.0 wt. % aqueous polymer solution XII was prepared by measuring 1.84 g of Elastron H-38 (trade name) (having an isocyanate group, Dai-Ichi Kogyo Seiyaku Co., Ltd.) having a solids concentration of 21.7% by weight and diluting the mixture with 6.16 g of ultrapure water.

### Preparation of a Coating Forming Composition

A coating forming composition having the following composition was prepared according to procedures similar to Example 1 except that 1.0 wt. % aqueous polymer solution XII was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Elastron H-38 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Elastron H-38 corresponded to 10 parts by weight based on 100 parts by weight of HPMC.

A transparent conductive film was prepared according to procedures similar to Example 1. The transparent conductive film obtained had a surface resistance value of 22.6 Ω/□, a total transmittance of 87.9% and a haze of 5.0%. Moreover, environmental resistance and process resistance were favorable.

### Example 15

### Preparation of Aqueous Polymer Solution XIII

Then, 1.0 wt. % aqueous polymer solution XIII was prepared by measuring 0.08 g of Nikalac MW-22 (trade name) (having an N-methylol ether group, Sanwa Chemical Co., Ltd.) having a solids concentration of 100% by weight and diluting the mixture with 7.92 g of ultrapure water.

### Preparation of a Coating Forming Composition

A coating forming composition having the following composition was prepared according to procedures similar to Example 1 except that 4.00 g of 0.8 wt. % binder solution II was used as a binder solution and 1.0 wt. % aqueous polymer solution XIII was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Nikalac MW-22 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Nikalac MW-22 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 32.1 Ω/□, a total transmittance of 91.5% and a haze of 1.4%. Moreover, environmental resistance and process resistance were favorable.

### Example 16

A coating forming composition having the following composition was prepared according to procedures similar to Example 15 except that an amount of 1.0 wt. % aqueous Nikalac MW-22 solution was changed to 0.08 g. The prepared coating forming composition showed favorable dispersibility.

| | | |
|---|---|---|
| Silver nanowires | 0.2 | % by weight |
| HPMC | 0.4 | % by weight |
| Nikalac MW-22 | 0.01 | % by weight |
| Triton X-100 | 0.004 | % by weight |
| Water | 99.386 | % by weight |

In addition, HPMC corresponded to 200 parts by weight based on 100 parts by weight of silver nanowires and Nikalac MW-22 corresponded to 2.5 parts by weight based on 100 parts by weight of HPMC.

A transparent conductive film was prepared according to procedures similar to Example 1 except that spin coating was performed at 1,000 rpm. The transparent conductive film obtained had a surface resistance value of 30.9 Ω/□, a total transmittance of 91.4% and a haze of 1.4%. Moreover, environmental resistance and process resistance were favorable.

### Example 17

A coating forming composition having the following composition was prepared according to procedures similar to Example 15 except that an amount of 1.0 wt. % aqueous Nikalac MW-22 solution was changed to 1.28 g. The prepared coating forming composition showed favorable dispersibility.

| | | |
|---|---|---|
| Silver nanowires | 0.2 | % by weight |
| HPMC | 0.4 | % by weight |
| Nikalac MW-22 | 0.16 | % by weight |
| Triton X-100 | 0.004 | % by weight |
| Water | 99.236 | % by weight |

In addition, HPMC corresponded to 200 parts by weight based on 100 parts by weight of silver nanowires and Nikalac MW-22 corresponded to 40 parts by weight based on 100 parts by weight of HPMC.

A transparent conductive film was prepared according to procedures similar to Example 1 except that spin coating was performed at 1,000 rpm. The transparent conductive film obtained had a surface resistance value of 121 Ω/□, a total transmittance of 89.7% and a haze of 0.7%. Moreover, environmental resistance and process resistance were favorable.

### Example 18

A coating forming composition having the following composition was prepared according to procedures similar to Example 1 except that 4.00 g of 0.8 wt. % binder solution IV was used as a binder solution and 1.0 wt. % aqueous polymer solution XIII was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Nikalac MW-22 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Nikalac MW-22 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 33.5 Ω/□, a total transmittance of 91.3% and a haze of 1.4%. Moreover, environmental resistance and process resistance were favorable.

### Example 19

### Preparation of aqueous polymer solution XIV

Then, 1.0 wt. % aqueous polymer solution XIV was prepared by measuring 0.114 g of Nikalac MW-30 (trade name) (having an N-methylol ether group, Sanwa Chemical Co., Ltd.) having a solids concentration of 100% by weight and diluting the mixture with 7.886 g of ultrapure water.

### Preparation of a Coating Forming Composition

A coating forming composition having the following composition was prepared according to procedures similar to Example 1 except that 4.00 g of 0.8 wt. % binder solution II was used as a binder solution and 1.0 wt. % aqueous polymer solution XIV was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Nikalac MW-30 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Nikalac MW-30 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 32.7 Ω/□, a total transmittance of 91.5% and a haze of 1.5%. Moreover, environmental resistance and process resistance were favorable.

### Example 20

### Preparation of Aqueous Polymer Solution XV

Then, 1.0 wt. % aqueous polymer solution XV was prepared by measuring 0.1143 g of Nikalac MX-035 (trade name) (having an N-methylol ether group, Sanwa Chemical Co., Ltd.) having a solids concentration of 100% by weight and diluting the mixture with 7.8857 g of ultrapure water.

### Preparation of a Coating Forming Composition

A coating forming composition having the following composition was prepared according to procedures similar to Example 1 except that 4.00 g of 0.8 wt. % binder solution II was used as a binder solution and 1.0 wt. % aqueous polymer solution XV was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Nikalac MX-035 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Nikalac MX-035 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 36.5 Ω/□, a total transmittance of 91.5% and a haze of 1.5%. Moreover, environmental resistance and process resistance were favorable.

### Example 21

### Preparation of Aqueous Polymer Solution XVI

Then, 1.0 wt. % aqueous polymer solution XVI was prepared by measuring 0.08 g of Nikalac MW-30 (trade name) (having an N-methylol ether group, Sanwa Chemical Co., Ltd.) having a solids concentration of 100% by weight and diluting the mixture with 7.92 g of isopropyl alcohol.

### Preparation of a Coating Forming Composition

A coating forming composition having the following composition was prepared according to procedures similar to Example 1 except that 4.00 g of 0.8 wt. % binder solution II was used as a binder solution and 1.0 wt. % aqueous polymer solution XVI was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Nikalac MW-30 | 0.04 | % by weight |
| Triton X-100 | 0.004 | % by weight |
| Water | 95.356 | % by weight |
| Isopropyl alcohol | 4 | % by weight |

In addition, HPMC corresponded to 200 parts by weight based on 100 parts by weight of silver nanowires and Nikalac MW-30 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 33.7 Ω/□, a total transmittance of 91.5% and a haze of 1.4%. Moreover, environmental resistance and process resistance were favorable.

### Example 22

### Preparation of Aqueous Polymer Solution XVII

Then, 1.0 wt. % aqueous polymer solution XVII was prepared by measuring 0.114 g of Nikalac MW-22 having a solids concentration of 100% by weight (trade name) (having an N-methylol ether group, Sanwa Chemical Co., Ltd.) and diluting the mixture with 7.886 g of isopropyl alcohol.

### Preparation of a Coating Forming Composition

A coating forming composition having the following composition was prepared according to procedures similar to Example 1 except that 4.00 g of 0.8 wt. % binder solution II was used as a binder solution and 1.0 wt. % aqueous polymer solution XVII was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Nikalac MW-22 | 0.04 | % by weight |
| Triton X-100 | 0.004 | % by weight |
| Water | 95.356 | % by weight |
| Isopropyl alcohol | 4 | % by weight |

In addition, HPMC corresponded to 200 parts by weight based on 100 parts by weight of silver nanowires and Nikalac MW-22 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 33.1 Ω/□, a total transmittance of 91.5% and a haze of 1.4%. Moreover, environmental resistance and process resistance were favorable.

### Example 23

### Preparation of Aqueous Polymer Solution XVIII

Then, 1.0 wt. % aqueous polymer solution XVIII was prepared by measuring 0.1143 g of Nikalac MX-035 having a solids concentration of 100% by weight (trade name) (having an N-methylol ether group, Sanwa Chemical Co., Ltd.) and diluting the mixture with 7.8857 g of isopropyl alcohol.

### Preparation of a Coating Forming Composition

A coating forming composition having the following composition was prepared according to procedures similar to Example 1 except that 4.00 g of 0.8 wt. % binder solution II was used as a binder solution and 1.0 wt. % aqueous polymer solution XVIII was used as an aqueous polymer solution. The prepared coating forming composition showed favorable dispersibility.

| | | |
|---|---|---|
| Silver nanowires | 0.2 | % by weight |
| HPMC | 0.4 | % by weight |
| Nikalac MX-035 | 0.04 | % by weight |
| Triton X-100 | 0.004 | % by weight |
| Water | 95.356 | % by weight |
| Isopropyl alcohol | 4 | % by weight |

In addition, HPMC corresponded to 200 parts by weight based on 100 parts by weight of silver nanowires and Nikalac MX-035 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 37.1 Ω/□, a total transmittance of 91.5% and a haze of 1.5%. Moreover, environmental resistance and process resistance were favorable.

### Example 24

### Preparation of Aqueous Compound Solution I Having an Alkoxysilyl Group (the Third Component)

Then, 0.5 wt. % aqueous solution I was prepared by measuring 0.1 g of Sila-Ace 5330 (trade name) (compound having an amino group and an alkoxysilyl group, JNC Corporation) and diluting the mixture with 19.9 g of ultrapure water.

### Preparation of a Coating Forming Composition

A coating forming composition having the following composition was prepared according to procedures similar to Example 1 except that 4.00 g of 0.8 wt. % binder solution II was used as a binder solution and 0.5 wt. % aqueous solution I was used without using aqueous polymer solution I. The prepared coating forming composition showed favorable dispersibility.

| | | |
|---|---|---|
| Silver nanowires | 0.2 | % by weight |
| HPMC | 0.4 | % by weight |
| Sila-Ace S330 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Sila-Ace S330 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 36.4 Ω/□, a total transmittance of 91.1% and a haze of 1.5%. Moreover, environmental resistance and process resistance were favorable.

### Example 25

### Preparation of Aqueous Compound Solution II Having an Alkoxysilyl Group

Then, 0.5 wt. % aqueous solution II was prepared by measuring 0.1 g of Sila-Ace 5510 (trade name) (compound having an amino group and an alkoxysilyl group, JNC Corporation) and diluting the mixture with 19.9 g of ultrapure water.

### Preparation of a Coating Forming Composition

A coating forming composition having the following composition was prepared according to procedures similar to Example 1 except that 4.00 g of 0.8 wt. % binder solution II was used as a binder solution and 0.5 wt. % aqueous solution II was used without using aqueous polymer solution I. The prepared coating forming composition showed favorable dispersibility.

| | | |
|---|---|---|
| Silver nanowires | 0.2 | % by weight |
| HPMC | 0.4 | % by weight |
| Sila-Ace S510 | 0.04 | % by weight |
| Triton X-100 | 0.004 | % by weight |
| Water | 99.356 | % by weight |

In addition, HPMC corresponded to 200 parts by weight based on 100 parts by weight of silver nanowires and Sila-Ace S510 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 34.8 Ω/□, a total transmittance of 91.4% and a haze of 1.6%. Moreover, environmental resistance and process resistance were favorable.

### Example 26

### Preparation of Aqueous Compound Solution III Having an Alkoxysilyl Group

Then, 0.5 wt. % aqueous solution III was prepared by measuring 0.1 g of 1,2-bis(trimethoxysilyl)ethane (compound having alkoxysilyl groups at both ends, made by Tokyo Kasei Kogyo Co., Ltd.) and diluting the mixture with 19.9 g of ultrapure water.

### Preparation of a Coating Forming Composition

A coating forming composition having the following composition was prepared according to procedures similar to Example 1 except that 4.00 g of 0.8 wt. % binder solution II was used as a binder solution and 0.5 wt. % aqueous solution III was used without using aqueous polymer solution I. The prepared coating forming composition showed favorable dispersibility.

| | | |
|---|---|---|
| Silver nanowires | 0.2 | % by weight |
| HPMC | 0.4 | % by weight |
| 1,2-Bis(trimethoxysilyl)ethane | 0.04 | % by weight |
| Triton X-100 | 0.004 | % by weight |
| Water | 99.356 | % by weight |

In addition, HPMC corresponded to 200 parts by weight based on 100 parts by weight of silver nanowires and 1,2-bis(trimethoxysilyl)ethane corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 36.8 Ω/□, a total transmittance of 91.3% and a haze of 1.5%. Moreover, environmental resistance and process resistance were favorable.

### Example 27

A coating forming composition having the following composition was prepared according to procedures similar to Example 1 except that 4.00 g of 0.8 wt. % binder solution II was used as a binder solution and 0.5 wt. % aqueous solution I was added. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC-3 | 0.004 | % by weight |
| Sila-Ace S330 | 0.04 | % by weight |
| Triton X-100 | 0.004 | % by weight |
| Water | 99.312 | % by weight |

In addition, HPMC corresponded to 200 parts by weight based on 100 parts by weight of silver nanowires and Sila-Ace 5330 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 35.8 Ω/□, a total transmittance of 91.0% and a haze of 1.7%. Moreover, environmental resistance and process resistance were favorable.

### Example 28

A coating forming composition having the following composition was prepared according to procedures similar to Example 1 except that 4.00 g of 0.8 wt. % binder solution II was used as a binder solution and 0.5 wt. % aqueous solution II was added. The prepared coating forming composition showed favorable dispersibility.

| | | |
|---|---|---|
| Silver nanowires | 0.2 | % by weight |
| HPMC | 0.4 | % by weight |
| Riken Resin MM-35 | 0.04 | % by weight |
| Riken Fixer RC-3 | 0.004 | % by weight |
| Sila-Ace S510 | 0.04 | % by weight |
| Triton X-100 | 0.004 | % by weight |
| Water | 99.312 | % by weight |

In addition, HPMC corresponded to 200 parts by weight based on 100 parts by weight of silver nanowires and Sila-Ace 5510 corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 36.3 Ω/□, a total transmittance of 91.0% and a haze of 1.7%. Moreover, environmental resistance and process resistance were favorable.

### Example 29

A coating forming composition having the following composition was prepared according to procedures similar to Example 1 except that 4.00 g of 0.8 wt. % binder solution II was used as a binder solution and 0.5 wt. % aqueous solution III was used. The prepared coating forming composition showed favorable dispersibility.

| | | |
|---|---|---|
| Silver nanowires | 0.2 | % by weight |
| HPMC | 0.4 | % by weight |
| 1,2-Bis(trimethoxysilyl)ethane | 0.04 | % by weight |
| Triton X-100 | 0.004 | % by weight |
| Water | 99.356 | % by weight |

In addition, HPMC corresponded to 200 parts by weight based on 100 parts by weight of silver nanowires and 1,2-bis(trimethoxysilyl)ethane corresponded to 10 parts by weight based on 100 parts by weight of HPMC.

A transparent conductive film was prepared according to procedures similar to Example 1 except that spin coating was performed at 1,000 rpm. The transparent conductive film obtained had a surface resistance value of 35.3 Ω/□, a total transmittance of 91.1% and a haze of 1.7%. Moreover, environmental resistance and process resistance were favorable.

### Example 30

A coating forming composition having the following composition was prepared according to procedures similar to Example 1 except that 4.00 g of 0.8 wt. % binder solution II was used as a binder solution and 0.16 g of 0.5 wt. % aqueous solution I was used without using aqueous polymer solution I. The prepared coating forming composition showed favorable dispersibility.

| | | |
|---|---|---|
| Silver nanowires | 0.2 | % by weight |
| HPMC | 0.4 | % by weight |
| Sila-Ace S330 | 0.02 | % by weight |
| Triton X-100 | 0.004 | % by weight |
| Water | 99.376 | % by weight |

In addition, HPMC corresponded to 200 parts by weight based on 100 parts by weight of silver nanowires and Sila-Ace 5330 corresponded to 5 parts by weight based on 100 parts by weight of HPMC.

A transparent conductive film was prepared according to procedures similar to Example 1 except that spin coating was performed at 1,000 rpm. The transparent conductive film obtained had a surface resistance value of 34.0 Ω/□, a total transmittance of 91.0% and a haze of 1.7%. Moreover, environmental resistance and process resistance were favorable.

### Example 31

A coating forming composition having the following composition was prepared according to procedures similar to Example 1 except that 4.00 g of 0.8 wt. % binder solution II was used as a binder solution and 0.08 g of 0.5 wt. % aqueous solution I was used without using aqueous polymer solution I. The prepared coating forming composition showed favorable dispersibility.

| | | |
|---|---|---|
| Silver nanowires | 0.2 | % by weight |
| HPMC | 0.4 | % by weight |
| Sila-Ace S330 | 0.01 | % by weight |
| Triton X-100 | 0.004 | % by weight |
| Water | 99.386 | % by weight |

In addition, HPMC corresponded to 200 parts by weight based on 100 parts by weight of silver nanowires and Sila-Ace 5330 corresponded to 2.5 parts by weight based on 100 parts by weight of HPMC.

A transparent conductive film was prepared according to procedures similar to Example 1 except that spin coating was performed at 4,000 rpm. The transparent conductive film obtained had a surface resistance value of 65.0 Ω/□, a total transmittance of 93.0% and a haze of 0.7%. Moreover, environmental resistance and process resistance were favorable.

### Example 32

### Patterning of a Transparent Conductive Film

On the transparent conductive film prepared according to Example 1, 1 mL of ZPP-1700PG (trade name) (Nippon Zeon Co., Ltd.) being a positive photoresist was dropped and spin coating was performed at 4,000 rpm using a spin coater. The glass substrate was calcinated on a hot stage at 100° C. for 90 seconds. A UV light was irradiated on the photoresist from above under conditions of 50 mJ/cm² through a chromium-deposited photomask using an exposure system (HB-20201CL model, extra high voltage mercury lamp as a light source, USH-2004To model, Ushio, Inc.). A coating after UV irradiation was immersed into a 2.38 wt. % aqueous tetramethylammonium hydroxide solution (trade name; TMA-208, Kanto Chemical Co., Inc.) for 30 seconds, an exposed part was removed, and thus development was performed. A coating after a development operation was immersed into Al etching solution (trade name) (Kanto Chemical Co., Inc.) for 30 seconds, and thus exposed silver nanowires in a transparent conductive film was etched. The photoresist was removed by immersing a coating after etching into acetone for 2 minutes. Dry air was blown onto the coating and the substrate using an air gun, and thus drying was performed.

Observation was performed using an incident-light darkfield microscope having a magnification of 500 times. A dot-line-space having a diameter or width of 5 micrometers was formed. Moreover, neither absence nor peeling of patterns was observed, and patterning was favorably performed.

### Example 33

### Confirmation of a Margin of Patterning

Patterning of a transparent conductive film was performed according to a composition and procedures similar to Example 32 except that immersion time into the Al etching solution was changed to 15, 30, 45, 60, 90, 120, 180, and 300 seconds. Observation was performed using an incident-light darkfield microscope having a magnification of 500 times. A dot-line-space and a reverse pattern having a diameter or width of 5 micrometers were formed under any conditions. Moreover, neither absence nor peeling of patterns was observed on the transparent conductive film, and patterning was favorably performed.

### Comparative Example 1

A coating forming composition as described in Example 17 of WO 2008/046058 A was prepared according the procedures as described below. In addition, a component amount was appropriately determined so as to show a desired surface resistance. A coating forming composition having the following composition was obtained by measuring 4.00 g of 0.8 wt. % binder solution I, 1.60 g of 1.0 wt. % aqueous silver nanowires dispersion solution and 2.40 g of ultrapure water, and agitated until a uniform solution was formed. The prepared coating forming composition had a viscosity of 56 mPa·s, and showed a favorable dispersibility even after 1 week.

| | | |
|---|---|---|
| Silver nanowires | 0.2 | % by weight |
| HPMC | 0.4 | % by weight |
| Triton X-100 | 0.004 | % by weight |
| Water | 99.396 | % by weight |

In addition, HPMC corresponded to 200 parts by weight based on 100 parts by weight of silver nanowires.

A transparent conductive film was prepared according to procedures similar to Example 1. The transparent conductive film obtained had a surface resistance value of 48.2 Ω/□, a total transmittance of 92.0% and a haze of 1.3%. Moreover, environmental resistance, process resistance and close contact were not sufficient, and inferior to the coating forming composition according to the present invention. Furthermore, the environmental resistance, the process resistance and the close contact were not sufficient even on silicon nitride and an overcoat (product name; PIG-7424, JNC Corporation), and inferior to the coating forming composition according to the present invention.

The environmental resistance, the process resistance and the close contact were confirmed to be poor because a component constitution in Comparative Example 2 was different from the coating forming composition of the present invention.

### Comparative Example 2

According to JP 2010-205532 A, a film of silver nanowires and a crosslinkable compound was formed in a first layer, and a film of an organic conductive material was formed in a second layer. The film of the first layer as described in Preparation of Transparent Electrode 108 in Example of JP 2010-205532 A was formed according to the procedures as described below.

Thus, 3.20 g of an aqueous solution of PVA 203 (trade name) (Kuraray Co., Ltd., 3.4 mPa·s in viscosity of a 4 wt. % aqueous solution) that was diluted to 1.0 wt. %, 0.32 g of 0.1 wt % aqueous Triton X-100 solution, and 2.48 g of ultrapure water were measured, and agitated until a uniform solution was formed. Then, 1.60 g of 1.0 wt. % aqueous silver nanowires dispersion solution was added, and agitated until a uniform solution was formed. Furthermore, 0.40 g of an aqueous solution of glyoxal (Wako Pure Chemical Industries, Ltd.) that was diluted to 0.1 wt. % was added, agitated until a uniform solution was formed, and thus a coating forming composition having the following composition was obtained. As for the prepared coating forming composition, precipitates of silver nanowires were observed on a bottom of a screw vial after 1 week, and dispersibility was poor.

| | | |
|---|---|---|
| Silver nanowires | 0.2 | % by weight |
| PVA 203 | 0.05 | % by weight |
| Glyoxal | 0.005 | % by weight |
| Triton X-100 | 0.004 | % by weight |
| Water | 99.741 | % by weight |

In addition, PVA 203 corresponded to 25 parts by weight based on 100 parts by weight of silver nanowires and glyoxal corresponded to 10 parts by weight based on 100 parts by weight of PVA 203.

A transparent conductive film was prepared according to procedures similar to Example 1. The transparent conductive film obtained had a surface resistance value of 150 Ω/□, a total transmittance of 92.3% and a haze of 0.9%. Moreover, environmental resistance, process resistance and close contact were poor.

The environmental resistance, the process resistance and the close contact were confirmed to be poor because a component constitution in Comparative Example 2 was different from the coating forming composition of the present invention.

### Comparative Example 3

According to JP 2010-205532 A, a film of silver nanowires and a crosslinkable compound was formed in a first layer, and a film of an organic conductive material was formed in a second layer. The film of the first layer as described in Preparation of Transparent Electrode 113 in Example of JP 2010-205532 A was formed according to the procedures as described below.

Thus, 3.20 g of an aqueous solution of PVA 203 (trade name) (Kuraray Co., Ltd., 3.4 mPa·s in viscosity of a 4 wt. % aqueous solution) that was diluted to 1.0 wt. %, 0.32 g of 0.1 wt. % aqueous Triton X-100 solution, and 2.48 g of ultrapure water were measured, and agitated until a uniform solution was formed. Then, 1.60 g of 1.0 wt. % aqueous silver nanowires dispersion solution was added, and agitated until a uniform solution was formed. Furthermore, 0.40 g of aqueous Riken Resin MM-35 solution diluted to 0.1 wt. o, and 0.40 g of aqueous Riken Fixer RC-3 solution diluted to 0.1 wt. % were added, agitated until becoming uniform, and thus a coating forming composition having the following composition was obtained. As for the prepared coating forming composition, precipitates of silver nanowires were observed on a bottom of a screw vial after 1 week, and dispersibility was poor.

| | | |
|---|---|---|
| Silver nanowires | 0.2 | % by weight |
| PVA 203 | 0.05 | % by weight |
| Riken Resin MM-35 | 0.005 | % by weight |
| Riken Fixer RC-3 | 0.005 | % by weight |
| Triton X-100 | 0.004 | % by weight |
| Water | 99.736 | % by weight |

In addition, PVA 203 corresponded to 25 parts by weight based on 100 parts by weight of silver nanowires, Riken Resin MM-35 corresponded to 10 parts by weight based on 100 parts by weight of PVA 203, and Riken Fixer RC-3 corresponded to 100 parts by weight based on 100 parts by weight of Riken Resin MM-35.

A transparent conductive film was prepared according to procedures similar to Example 1. As for the prepared coating forming composition, precipitates of silver nanowires were observed on a bottom of a screw vial after 1 week, and dispersibility was poor. The transparent conductive film obtained had a surface resistance value of 142 Ω/□, a total transmittance of 93.0% and a haze of 0.6%. Moreover, environmental resistance, process resistance and close contact were poor.

The environmental resistance, the process resistance and the close contact were confirmed to be poor because a component constitution in Comparative Example 2 was different from the coating forming composition of the present invention.

### Comparative Example 4

### Confirmation of a Margin of Patterning

Patterning of a transparent conductive film was performed in a manner similar to Example 33 except that the coating forming composition prepared in Comparative Example 1 was used. Observation was performed using an incident-light darkfield microscope having a magnification of 500 times. When immersion time into Al etching solution was 15 or 30 seconds, a dot-line-space and a reverse pattern having a diameter or width of 5 micrometers were formed. When the immersion time into Al etching solution was 45 seconds or more, a diameter or width of a pattern decreased in proportion to the immersion time, a diameter or width of the reverse pattern increased in proportion to the immersion time, and thus the coating forming composition of the present invention was confirmed to have a broader margin of patterning.

TABLE 1

| | | Conduc- | | | | |
|---|---|---|---|---|---|---|
| | | tivity | | | | |
| | | Surface | Transparency | | Envi- | |
| | | resis- | Total | | ron- | |
| | Disper- | tance | transmit- | | mental | Proces |
| Sample | sibil- | value | tance | Haze | resis- | resis- |
| name | ity | (Ω/□) | (%) | (%) | tance | tance |
| Example 1 | Good | 47.4 | 91.4 | 1.6 | Good | Excellent |
| Example 2 | Good | 43.9 | 91.3 | 1.6 | Good | Good |
| Example 3 | Good | 103 | 89.3 | 0.8 | Good | Excellent |
| Example 4 | Good | 30.8 | 91.2 | 1.7 | Good | Excellent |
| Example 5 | Good | 29.8 | 91.2 | 1.8 | Good | Excellent |
| Example 6 | Good | 60.3 | 92.0 | 1.3 | Good | Good |
| Example 7 | Good | 33.8 | 91.8 | 1.3 | Good | Excellent |
| Example 8 | Good | 51.1 | 91.3 | 1.6 | Good | Excellent |
| Example 9 | Good | 52.8 | 91.2 | 1.5 | Good | Excellent |
| Example 10 | Good | 54.0 | 91.4 | 1.5 | Good | Excellent |
| Example 11 | Good | 31.4 | 90.4 | 2.4 | Good | Good |
| Example 12 | Good | 36.0 | 91.1 | 5.9 | Good | Excellent |
| Example 13 | Good | 25.7 | 88.3 | 3.8 | Good | Good |
| Example 14 | Good | 22.6 | 87.9 | 5.0 | Good | Excellent |
| Example 15 | Good | 32.1 | 91.5 | 1.4 | Good | Excellent |
| Example 16 | Good | 30.9 | 91.4 | 1.4 | Good | Good |
| Example 17 | Good | 121 | 89.7 | 0.7 | Good | Excellent |
| Example 18 | Good | 33.5 | 91.5 | 1.4 | Good | Excellent |
| Example 19 | Good | 32.7 | 91.5 | 1.5 | Good | Excellent |
| Example 20 | Good | 36.5 | 91.5 | 1.5 | Good | Excellent |
| Example 21 | Good | 33.7 | 91.5 | 1.4 | Good | Excellent |
| Example 22 | Good | 33.1 | 91.5 | 1.4 | Good | Excellent |
| Example 23 | Good | 37.1 | 91.5 | 1.5 | Good | Excellent |
| Example 24 | Good | 36.4 | 91.1 | 1.5 | Good | Excellent |
| Example 25 | Good | 34.8 | 91.4 | 1.6 | Good | Excellent |
| Example 26 | Good | 36.8 | 91.3 | 1.5 | Good | Excellent |
| Example 27 | Good | 35.8 | 91.0 | 1.7 | Good | Excellent |
| Example 28 | Good | 36.3 | 91.0 | 1.7 | Good | Excellent |
| Example 29 | Good | 35.3 | 91.1 | 1.7 | Good | Excellent |
| Example 30 | Good | 34.0 | 91.0 | 1.7 | Good | Excellent |
| Example 31 | Good | 65.0 | 93.0 | 0.7 | Good | Excellent |
| Comparative | Good | 48.2 | 92.0 | 1.3 | Mar- | Bad |
| Example 1 | | | | | ginal | |
| Comparative | Bad | 150 | 92.3 | 0.9 | Bad | Bad |
| Example 2 | | | | | | |
| Comparative | Bad | 142 | 93.0 | 0.6 | Mar- | Bad |
| Example 3 | | | | | ginal | |

### INDUSTRIAL APPLICABILITY

A coating forming composition of the present invention can be used in a process for manufacturing a device element such as a liquid crystal display element, an organic electroluminescence element, an electronic paper, a touch panel element and a photovoltaic cell element. Moreover, a transparent conductive film of the present invention is excellent in conductivity, optical transparency, environmental resistance, process resistance and close contact, and has a low surface resistance value and favorable optical properties such as a favorable transmittance as well.

Although the present invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A coating forming composition, comprising at least one kind of materials selected from the group of metal nanowires and metal nanotubes as a first component, at least one kind of materials selected from the group of polysaccharides and a derivative thereof as a second component, a compound having at least one group selected from the group of a (block) isocyanate group, an amineimide group, an epoxy group, an oxetanyl group, an N-methylol group, an N-methylol ether group and an alkoxysilyl group as a third component, and water as a fourth component.

2. The coating forming composition according to claim 1, wherein the third component comprises a compound having the N-methylol group or the N-methylol ether group.

3. The coating forming composition according to claim 2, wherein the third component is a condensation product of at least one kind of compounds shown in the following group (A) and at least one kind of compounds shown in the following group (B):
(A) formaldehyde, paraformaldehyde and trioxane; and
(B) urea, melamine and benzoguanamine.

4. The coating forming composition according to claim 3, wherein the third component is a condensation product of formaldehyde and melamine.

5. The coating forming composition according to claim 4, wherein the third component comprises a compound having the N-methylol ether group.

6. The coating forming composition according to claim 1, wherein the third component comprises a compound having the alkoxysilyl group.

7. The coating forming composition according to claim 6, wherein the compound having the alkoxysilyl group comprises an amino group or an epoxy group.

8. The coating forming composition according to claim 7, wherein the third component comprises a compound represented by the following general formula (I) or (II): 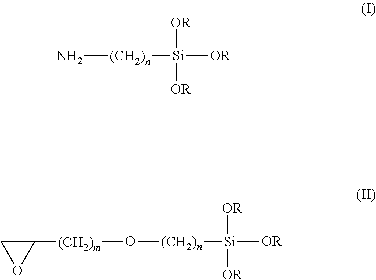
wherein R independently represents an alkyl group having 1 to 3 carbons, and n and m are independently an integer of 2 to 5.

9. The coating forming composition according to claim 6, wherein the third component comprises a compound represented by the following general formula (III): 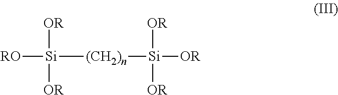
wherein R independently represents an alkyl group having 1 to 3 carbons, and n is an integer of 2 to 5.

10. The coating forming composition according to claim 1, wherein the first component comprises silver nanowires.

11. The coating forming composition according to claim 10, wherein the first component comprises silver nanowires having a mean of length of a minor axis in the range of 5 nanometers or more to 100 nanometers or less, and a mean of length of a major axis in the range of 2 micrometers or more to 50 micrometers or less.

12. The coating forming composition according to claim 1, wherein the second component comprises a cellulose ether derivative.

13. The coating forming composition according to claim 12, wherein the second component comprises hydroxypropyl methyl cellulose.

14. The coating forming composition according to claim 1, comprising at least one kind of compounds selected from an amine compound, salts and metal salts of the amine compound.

15. The coating forming composition according to claim 1, wherein the first component is in the range of 0.01% by weight or more to 1.0% by weight or less based on the total weight of the coating forming composition, the second component is in the range of 50 parts by weight or more to 300 parts by weight or less based on 100 parts by weight of the first component, and the third component is in the range of 1.0 part by weight or more to 50 parts by weight or less based on 100 parts by weight of the second component.

16. The coating forming composition according to claim 1, wherein viscosity at 25° C. is in the range of 10 mPa·s or more to 70 mPa·s or less.

17. The coating forming composition according to claim 1, used for forming a coating having conductivity.

18. A substrate having a transparent conductive film obtained using the coating forming composition according to claim 17, wherein a film thickness of the transparent conductive film is in the range of 20 nanometers or more to 80 nanometers or less, a surface resistance of the transparent conductive film is in the range of 10 Ω/□ or more to 5,000 Ω/□ or less, and a total transmittance of the transparent conductive film is in the range of 85% or more.

19. A device element, using the substrate according to claim 18.
